(19) United States
(12) Patent Application Publication
(10) Pub. No.: US 2014/0071966 A1
(43) Pub. Date: Mar. 13, 2014

(54) WIRELESS TERMINAL, WIRELESS COMMUNICATION METHOD, AND WIRELESS COMMUNICATION SYSTEM

(71) Applicants: Yukio Shikatani, Kanagawa (JP); Shinkichi Ikeda, Kanagawa (JP)

(72) Inventors: Yukio Shikatani, Kanagawa (JP); Shinkichi Ikeda, Kanagawa (JP)

(73) Assignee: Panasonic Corporation, Osaka (JP)

(21) Appl. No.: 14/118,056

(22) PCT Filed: May 18, 2012
(86) PCT No.: PCT/JP2012/003255

§ 371 Date: Nov. 21, 2013

(30) Foreign Application Priority Data
Jun. 2, 2011 (JP) 2011-124388

(51) Int. Cl. H04L 5/00

(52) U.S. Cl. CPC H04L 5/0082
USPC 370/336

(57) ABSTRACT

Provided is a wireless terminal capable of transmitting accompanying information in an ad-hoc network to an external network in a state in which the incidence of missing information is minimized. In this device, ad-hoc communication and external communication are performed at different timings. Node function determination unit (120) determines a representative terminal shared by a plurality of terminals in every interval obtained by dividing a time axis. Wireless communication unit (130) performs ad-hoc communication in an interval in which the wireless terminal is not the representative terminal. Communication data management unit (140) stores representative terminal information indicating which of the terminals is the representative terminal, and communication history for ad-hoc communication. Output data generator (160) sends the communication history and the representative terminal information in a mutually associated state to the external network using external interface unit (150) during an interval in which the wireless terminal is the representative terminal.

### TECHNICAL FIELD

The present invention relates to a wireless terminal, a wireless communication method, and a wireless communication system that transmit a communication history of an ad-hoc network to an external network.

### BACKGROUND ART

Wireless terminals, such as portable games, which share and use mutual data via ad-hoc networks freely set up outdoors and the like are widely used. Such wireless terminals have an application that performs P2P (peer-to-peer) data exchange using, for example, a near-field communication system such as wireless LAN in accordance with the IEEE 802.11 standard.

A history of ad-hoc network communication (hereinafter “ad-hoc communication”) is information (hereinafter “accompanying information”) indicating what other wireless terminals have come into proximity with that wireless terminal. Analyzing the accompanying information of many wireless terminals enables the user of each wireless terminal to estimate with high precision who and when and to which terminal the user approached or where the user was.

Given the above, this is expected to be useful in collecting accompanying information from many wireless terminals for use in search systems for persons missing, and requiring rescue, child monitoring systems, and movement monitoring systems.

However, in order to implement such data collection, each wireless terminal needs to either accumulate a communication history over a long period of time, or transmit a communication history to a server with a relatively short cycle. In a portable wireless terminal in which it is difficult to include a large-capacity memory and in a system requiring real-time collection of accompanying information, it is necessary to transmit a communication history to a server or the like substantially in real-time with a short cycle.

Particularly in the case of a portable wireless terminal, the CPU (central processing unit) controlling the device generally has low resources and also inevitably operates in single-task mode. That is, there are many wireless terminals that cannot simultaneously perform ad-hoc communication and external network side communication (hereinafter, “external communication”).

In the case of external communication and ad-hoc communication using the same system, it is impossible for a wireless terminal to perform two communications simultaneously. This is attributed to the operation of a device processing the communication system. For example, in the case of performing external communication and ad-hoc communication exclusively by time division, each of the communications is performed only during the time allocated to the wireless terminal. In the case of performing external communication and ad-hoc communication exclusively by frequency division, the wireless terminal can only perform transmitted data modulation and received data demodulation regarding one of the communications at any given time.

Given this, art described, for example, in Patent Literature 1 performs ad-hoc communication using the time in which external communication is not performed. In this manner, the related art performs both ad-hoc communication and external communication and can transmit an ad-hoc communication history to an external network.

### CITATION LIST

### Patent Literature

### PTL 1

Japanese Patent Application Laid-Open No. 2003-249939

### SUMMARY OF INVENTION

### Technical Problem

The related art, however, has the problem that accompanying information to be transmitted to an external network often may not actually be transmitted.

The reason for this is as follows. Because of an increase in the amount of data in the ad-hoc communication history, the influence of delays in the processing at the external communication destination and other factors, the CPU occupation rate for processing of external communication may become high. In such cases, the amount of time that the wireless terminal can perform ad-hoc communication becomes small, and the amount of time that it cannot receive transmitted data from a nearby terminal becomes long. When this occurs, with regard to another wireless terminal passing by at close range thereto, the wireless terminal cannot obtain the accompanying information therefrom, even though it has been within close range. That is, a drop-out (missing) of the ad-hoc communication history occurs.

An object of the present invention is to provide a wireless terminal, a wireless communication method, and a wireless communication system that can transmit accompanying information of an ad-hoc network to an external network while reducing drop-outs.

### Solution to Problem

A wireless terminal according to an aspect of the present invention is a terminal that is one of a plurality of terminals forming an ad-hoc network and that performs ad-hoc communication and external communication at different times, the wireless terminal including: a node function judgment section that determines a representative terminal common to the plurality of terminals, for each time section made by dividing a time axis; a wireless communication section that performs the ad-hoc communication in a time section in which the wireless terminal is not the representative terminal; a communication data management section that stores a communication history of the ad-hoc communication and representative terminal information indicating which terminal was the representative terminal; an external interface section that performs the external communication; and an output data generation section that, in the time section in which the wireless terminal is the representative terminal, transmits to an external network, using the external interface section, the communication history and representative terminal information in association with each other.

A wireless communication method according to an aspect of the present invention is a method in a wireless terminal that is one of a plurality of terminals forming an ad-hoc network and that performs ad-hoc communication and external communication at different times, the method including: determining a representative terminal common to the plurality of terminals, for each time section made by dividing a time axis; performing the ad-hoc communication in a time section in which the wireless terminal is not the representative terminal; accumulating a communication history of the ad-hoc communication; and transmitting, to an external network, in the time section in which the wireless terminal is the representative terminal, the communication history and representative terminal information indicating which wireless terminal is the representative terminal in association with each other.

A wireless communication system according to an aspect of the present invention is a system including a plurality of wireless terminals each being one of a plurality of terminals foiling an ad-hoc network and performing ad-hoc communication and external communication at different times, in which the wireless terminal includes: a node function judgment section that determines a representative terminal common to the plurality of terminals, for each time section made by dividing the time axis; a wireless communication section that performs the ad-hoc communication in a time section in which the wireless terminal is not the representative terminal; a communication data management section that stores a communication history of the ad-hoc communication and representative terminal information indicating which terminal was the representative terminal; an external interface section that performs the external communication; and an output data generation section that, in the time section in which the wireless terminal is the representative terminal, transmits to an external network, using the external interface section, the communication history and representative terminal information in association with each other, in which the plurality of wireless terminals include a terminal that is previously set as the representative terminal.

### Advantageous Effects of Invention

According to the present invention, it is possible to transmit accompanying information of an ad-hoc network to an external network while reducing drop-outs.

### BRIEF DESCRIPTION OF DRAWINGS

FIG. 1 is a block diagram showing an example of the configuration of a wireless terminal according to Embodiment 1 of the present invention;

FIG. 2 is a schematic view showing a general accompanying information collection system used by a wireless terminal (node) in Embodiment 2 of the present invention;

FIG. 3 is a drawing showing, in schematic form, the P2P communication condition in a node in Embodiment 2 of the present invention;

FIG. 4 is a drawing showing, in schematic form, the condition of P2P communication in an overall ad-hoc network in Embodiment 2 of the present invention;

FIG. 5 is a drawing showing, in schematic form, an example of the configuration of P2P wireless data in Embodiment 2 of the present invention;

FIG. 6 is a drawing showing, in schematic form, an example of the configuration of output data in Embodiment 2 of the present invention;

FIG. 7A is a drawing showing an example of the hardware configuration of a node in Embodiment 2 of the present invention, and FIG. 7B is a drawing showing an example of the hardware configuration of a node in Embodiment 2 of the present invention;

FIG. 8 is a block diagram showing an example of the functional configuration of a node according to Embodiment 2 of the present invention;

FIG. 9 is a drawing showing an example of the configuration and contents of a communication history data table in Embodiment 2 of the present invention;

FIG. 10 is a drawing showing an example of the configuration and contents of representative node data in Embodiment 2 of the present invention;

FIG. 11 is a drawing showing an example of the configuration and contents of a representative node data table in Embodiment 2 of the present invention;

FIG. 12 is a flowchart showing an example of the overall operation of a node according to Embodiment 2 of the present invention;

FIG. 13 is flowchart showing an example of P2P wireless communication processing in Embodiment 2 of the present invention;

FIG. 14 is a flowchart showing an example of time slot processing in Embodiment 2 of the present invention;

FIG. 15 is a flowchart showing an example of node function judgment processing in Embodiment 2 of the present invention;

FIG. 16 is a flowchart showing an example of representative node processing in Embodiment 2 of the present invention;

FIG. 17 is a sequence diagram showing an example of the operational flow of each functional part of a node that is not a representative node in Embodiment 2 of the present invention;

FIG. 18 is a sequence diagram showing an example of the operational flow of each functional part of a node that is a representative node in Embodiment 2 of the present invention;

FIG. 19 is a first drawing showing the situation of the interchanging of representative nodes and the change in status of information stored by each node in Embodiment 2 of the present invention;

FIG. 20 is a second drawing showing the situation of the interchanging of representative nodes and the change in status of information stored by each node in Embodiment 2 of the present invention;

FIG. 21 is a third drawing showing the situation of the interchanging of representative nodes and the change in status of information stored by each node in Embodiment 2 of the present invention;

FIG. 22 is a drawing showing another example of the configuration and contents of a communication history data table in Embodiment 2 of the present invention;

FIG. 23A is a drawing showing another example of the hardware configuration of a node according to Embodiment 2 of the present invention, and FIG. 23B is a drawing showing another example of the hardware configuration of a node according to Embodiment 2 of the present invention;

FIG. 24 is a block diagram showing an example of the functional configuration a node according to Embodiment 3 of the present invention;

FIG. 25 is a flowchart showing an example of the overall operation of a node in Embodiment 3 of the present invention;

FIG. 26 is a flowchart showing an example of the node function judgment processing in Embodiment 3 of the present invention;

FIG. 27 is a block diagram showing an example of the functional configuration of a node in Embodiment 4 of the present invention;

FIG. 28 is a flowchart showing an example of the overall operation of a node in Embodiment 4 of the present invention;

FIG. 29 is a flowchart showing an example of representative node termination notification processing in Embodiment 4 of the present invention; and

FIG. 30 is a flowchart showing an example of representative node termination monitoring processing in Embodiment 4 of the present invention;

### DESCRIPTION OF EMBODIMENTS

Embodiments of the present invention are described below in detail, with references to drawings.

### Embodiment 1

Embodiment 1 of the present invention is an example of basic aspect of the present invention.

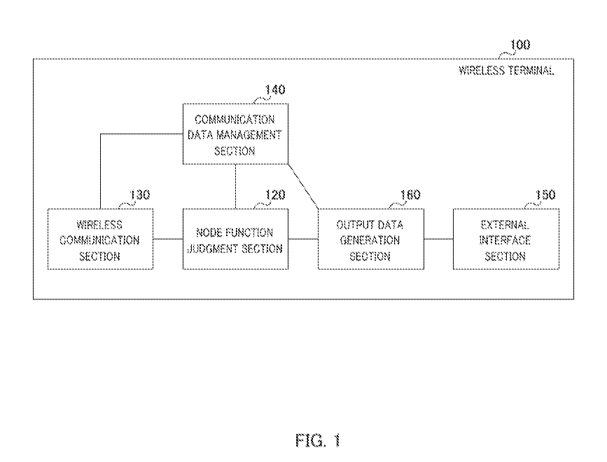

FIG. 1 is a block diagram showing an example of the configuration of a wireless terminal according to the present embodiment.

In FIG. 1, wireless terminal 100 is one of a plurality of terminals forming an ad-hoc network, and is a wireless terminal that performs ad-hoc communication and external communication with different timing. Wireless terminal 100 has node function judgment section 120, wireless communication section 130, communication data management section 140, external interface section 150, and output data generation section 160.

Node function judgment section 120 determines a representative terminal common to a plurality of terminals for each time section obtained by dividing the time axis. In the case of a system in which the transmission time slots in ad-hoc communication are randomly selected by each terminal, node function judgment section 120, for example, determines the terminal that has selected the time slot having the smallest slot number as the representative terminal.

Wireless communication section 130 performs the above-described ad-hoc communication in a time section in which wireless terminal 100 is not a representative terminal.

Communication data management section 140 stores the communication history of ad-hoc communication and representative terminal information indicating which terminal was the representative terminal.

External interface section 150 performs the above-described external communication.

Output data generation section 160, in a time section in which wireless terminal 100 is the representative terminal, transmits to an external network, using external interface section 150, a communication history and representative terminal information in association with each other

Wireless terminal 100 has, for example, a CPU, a storage medium such as RAM (random-access memory), and a wireless communication circuit. In this case, the above-noted functional parts are implemented by a CPU executing a control program.

Wireless terminals 100 such as this perform ad-hoc communication for each time section in which they are not representative terminals, and representative terminals can transmit to an external network a communication history all at once as accompanying information.

In this manner, by having representative terminals and those that are not representative terminals perforin different roles for each tune section, it is possible for wireless terminals 100 to avoid an increase in the CPU occupation rate for external communication processing in the overall ad-hoc network to a low level. Also wireless terminals 100 can make the ad-hoc communication time commensurately long for the overall ad-hoc network, enabling more reliable acquisition of information indicating the presence of another nearby terminal (hereinafter “presence information”) as a communication history.

However, a representative terminal does not perform ad-hoc communication in a time section in which it is a representative terminal. For this reason, another wireless terminal 100 cannot obtain presence information of the representative terminal from the communication history of that time section. The presence information of a representative terminal of that time section is stored as the communication history of ad-hoc communication in a past time section. Associating representative terminal information for that time section obtained from a past communication history and a communication history of ad-hoc communication in that time section with each other makes possible for another wireless terminal 100 to generate presence information of all nearby wireless terminals 100, including the representative terminal in that time section.

That is, wireless terminal 100 can prevent drop-out of presence information of the representative terminal, while also preventing drop-outs of presence information of terminals other than the representative terminal. Therefore, wireless terminal 100 can transmit accompanying information of an ad-hoc network to an external network while reducing drop-outs.

### Embodiment 2

Embodiment 2 of the present invention is an example of the present invention applied to a wireless terminal performing ad-hoc communication with another terminal using TDMA (time division multiple access) P2P communication.

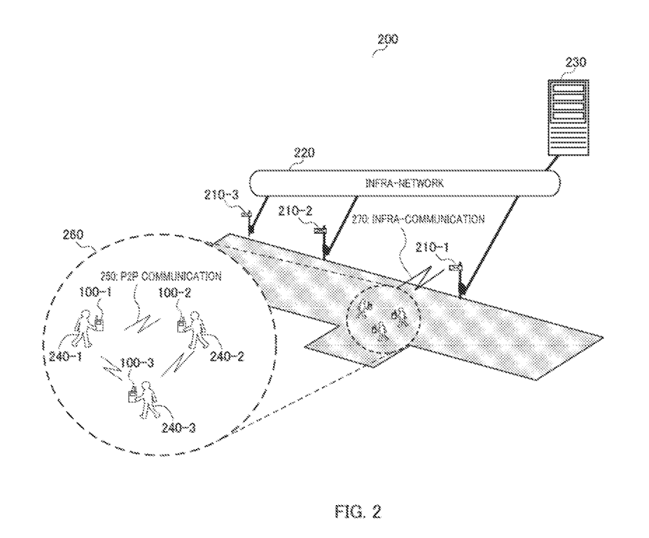

FIG. 2 is a schematic view showing a general accompanying information collection system used by a wireless terminal (hereinafter “node”) according to the present embodiment.

In FIG. 2, accompanying information collection system 200 has first to third nodes (hereinafter referred to as “node1,” “node2,” and “node3” as appropriate) 100-1 to 100-3, first to third wireless base stations 210-1 to 210-3, infra-network 220, and server 230, according to the present invention.

First to third wireless base stations 210-1 to 210-3 are, for example, installed along a road at a fixed spacing. First to third wireless base stations 210-1 to 210-3 each collect accompanying information from nodes positioned within the wireless area thereof, and transmit it to server 230, via infrastructure network (hereinafter, infra-network) 220, such as the Internet.

First to third nodes 100-1 to 100-3 are carried by first to third unidentified users 240-1 to 240-3 and for example approach nearby to each other in a communication area of first wireless base station 210-1. When this occurs, as shown in FIG. 2, first to third nodes 100-1 to 100-3 form an ad-hoc network 260 by ad-hoc communication 250.

Then, first to third nodes 100-1 to 100-3 transmit accompanying information indicating that they nearby approach to each other, for example, first wireless base station 210-1, by infrastructure wireless communication (external communication, hereinafter infra-communication) 270.

Server 230 compiles and analyzes accompanying information collected via first to third wireless base stations 210-1 to 210-3 from many nodes 100 (including those not Shown in the drawing), along with position information of the locations at which the accompanying information is obtained. By doing this, server 230 performs, for example, searching for a person or an object, or tracking of a route of a virus infection (droplet infection, airborne infection). Server 230 can also, for example, obtain position information, based on at which wireless base station 210 collection has been done.

First to third nodes 100-1 to 100-3 each perform ad-hoc communication 250 in ad-hoc network 260 and infra-communication 270 with first wireless base station 210-1. However, each node 100 does not perform ad-hoc communication 250 and infrastructure communication (hereinafter, infra-communication) 270 simultaneously.

The communication system of ad-hoc communication 250 of nodes 100 is a P2P communication system by time division multiple access. The time division multiple access system is a wireless communication system in which each of a plurality of terminals transmits and receives using radio signals of the same frequency, in units of time slots by partitioning in fixed time periods. In contrast, the communication system in infra-communication 270 of each node 100 is a client-server communication system.

A communication network that implements ad-hoc communication 250 and infra-communication 270 is near-field communication using UHF (ultra-high frequency), WiFi (wireless fidelity), or cellular technology. Specifically, although a configuration that can be envisioned is one in which ad-hoc communication 250 is performed via a near-field communication network in the UHF band, and infra-communication 270 is performed by a WLAN (wireless local area network) such as WiFi or cellular network, the combination of communication networks is not limited to this. That is, ad-hoc communication 250 and infra-communication 270 may both be performed via a WiFi network or both be performed by a cellular network, or both be performed by a near-field communication network. By applying the same communication network (same communication technology) to ad-hoc communication 250 and infra-communication 270 in this manner, it is possible to reduce the cost of the communication chip mounted in the terminal and reduce the power consumption.

The protocol of ad-hoc communication (hereinafter, “P2P” communication) 250 in the present embodiment will be described, hereinafter.

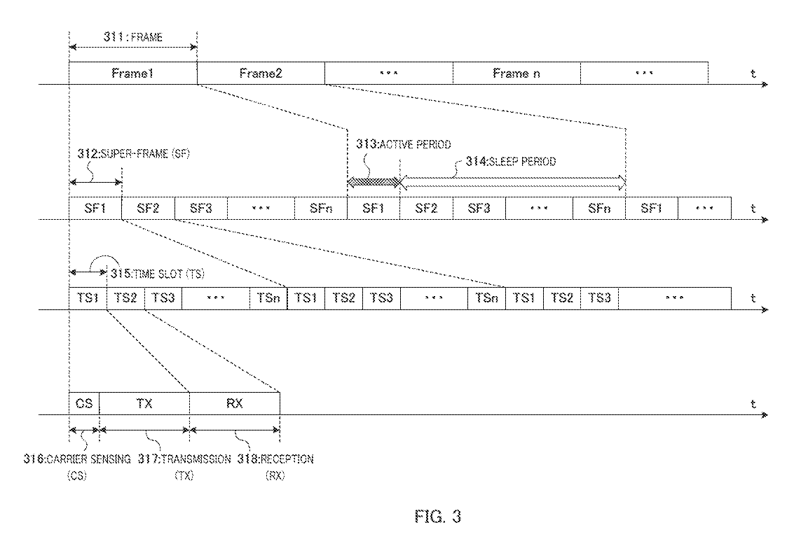

FIG. 3 is a drawing showing, in schematic form, the condition when P2P communication 250 in node 100 is viewed on the time axis. In FIG. 1, the horizontal axis represents time.

As shown in FIG. 3, in P2P communication 250, a plurality of frames 311 are continuously disposed with frame 311 as the unit. Each frame 311 is constituted by a plurality of super-frames (SF) 312. In this case, the illustration and description of the beacon, which will be described later, will be omitted. In the present embodiment, the first super-frame (SF1) of each frame 311 is taken to be an active period 313 used for communication. The remaining super-frames (SF2 to SFn) are taken to be sleep periods 314 that are not used for communication. Each super-frame 312 is constituted by a plurality of time slots (TS) 315.

Transmission and reception in P2P communication 250 are performed taking time slot 315 as the minimum unit. In some timeslot 315, node 100, for example as shown in FIG. 3, performs transmission (TX) 317 after carrier sensing (CS) 316, and performs reception (RX) 318 in a different time slot 315.

Node 100 need not perform carrier sensing 316 before transmission 317. However, by each node 100 performing carrier sensing 316, ad-hoc network 260 enables all nodes 100 to more reliably perform transmission in mutually different timeslots 315.

Specifically, each node 100, for each frame 311, temporarily determines time slots 315 for performing transmission 317 randomly, and remaining time slots 315 are temporarily determined as time slots 315 in which reception 318 is performed. Each node 100, by performing carrier sensing 316 in a time slot 315 temporarily determined for performing transmission 317, judges whether or not another node 100 is transmitting. Only if that node 100 has judged that another node 100 is not transmitting, does that node 100 performs actual transmission 317 in that time slot 315.

In the description to follow, first to third nodes 100-1 to 100-3 are described as always transmitting in mutually different time slots 315.

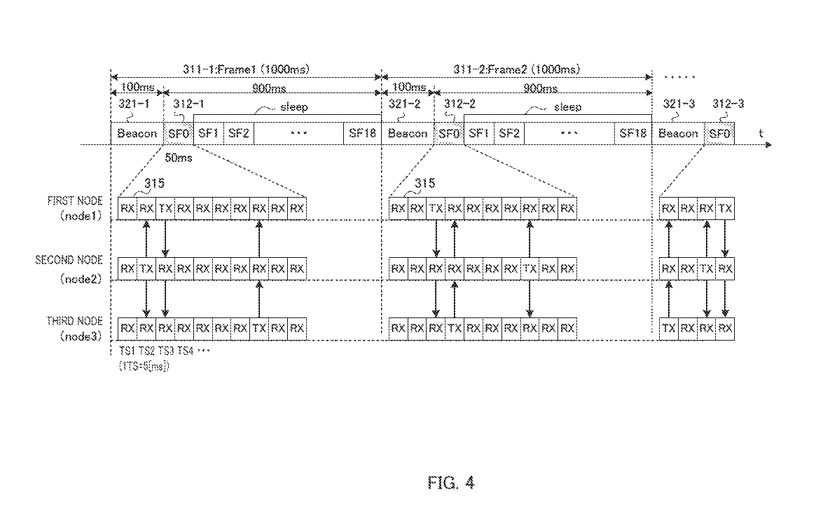

FIG. 4 is a drawing showing, in schematic form the condition of P2P communication 250 in the overall ad-hoc network 260, as seen on the time axis.

As shown in FIG. 4, beacon time sections 321-1, 321-2, and so on are disposed in each of frames 311-1, 311-2, and so on. In each frame 311-1, 311-2, and so on, following beacon time sections 321-1, 321-2, and so on, active period super-frames 312-1, 312-2, and so on are disposed.

For example, in a certain frame 311-1, the second node 100, the first node 100 and the third node 100 transmit in the second time slot 315, in the third time slot 315, and in the eighth time slot 315, respectively. Also, for example, in different frame 311-2, the tint node 100, the second node 100, and the third node 100 transmit in the third time slot 315, in the eight time slot 315, and in the fourth time slot 315, respectively.

First to third nodes 100-1 to 100-3, in the active periods of each frame 311, receive in a time slot other than the one in which the node itself transmits. Each node 100 can, therefore, receive data transmitted from all the other nodes 100 within ad-hoc network 260.

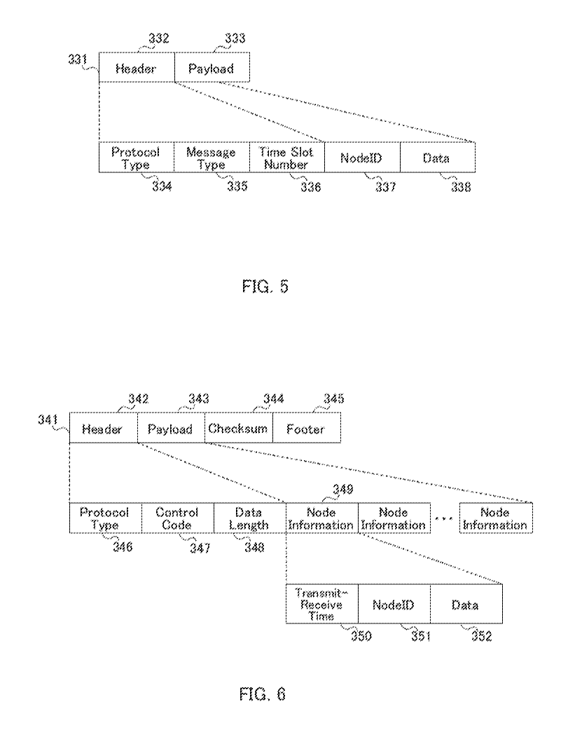

FIG. 5 is a drawing showing, in schematic form, an example of configuration of transmitted data (hereinafter, “P2P wireless data”) in P2P communication 250.

As shown in FIG. 5, P2P wireless data 331 is constituted by header 332 and payload 333. Header 332 stores protocol type 334, message type 335, and time slot number 336. Payload 333 stores node ID 337 and data 338.

Protocol type 334 indicates the protocol of P2P communication 250 that, for example, establishes the frame interval, the time slot interval, and the transfer rate.

Message type 335 indicates the type of data stored in payload 333, this indicating, for example, beacon ACK/response ACK, beacon NAK/response NAK, and control beacon and the like.

Time slot number 336 indicates the number of the tune slot used in transmission of P2P wireless data 331.

Node ID 337 indicates the transmission source node identifier (ID) of P2P wireless data 331.

Although data 338 is the data itself, it is not always necessary in the present embodiment.

That is, each time each node 100 receives P2P wireless data 331, node 100 can obtain the node ID of the transmission source from P2P wireless data 331. The transmission of P2P wireless data 331 from each node 100 is performed for each frame 331 at an extremely short cycle, such as 1000 ms (milliseconds). Each node 100 can therefore obtain the node 100 corresponding to which node ID is nearby (that is, accompanying information).

The description of the protocol of P2P communication 250 in the present embodiment has been given thus far.

Next, the protocol of infra-communication 270 in the present embodiment will be described.

Although the communication data format used in infra-communication 270 is not particularly restricted, an example thereof will be described.

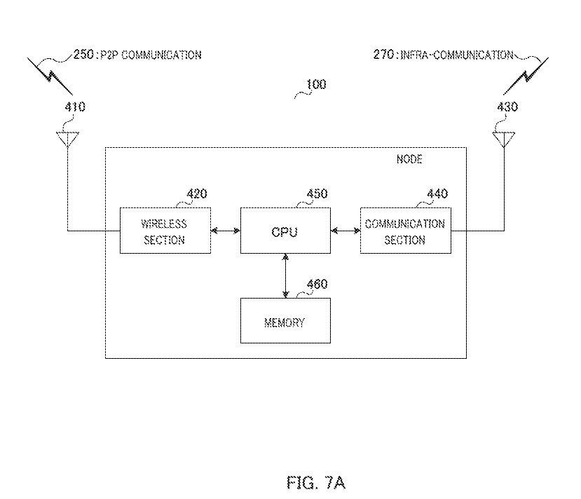

FIG. 6 is a drawing showing, in schematic form, an example of the configuration of data transmitted (hereinafter, “output data”) from node 100 in infra-communication 270.

As shown in FIG. 6, output data 341 is constituted by header 342, payload 343, checksum 344, and footer 345. Header 342 stores protocol type 346, control code 347, and data length 348 and the like. Payload 343 stores one or more node information 349. Each node information 349 stores transmit-receive time 350, node ID 351, and data 352 and the like.

Protocol type 346 indicates the protocol of infra-communication 270 that, example, establishes the frame interval, the time slot interval, and the transfer rate.

Control code 347 indicates that information related to P2P communication 250 is stored in payload 343.

Data length 348 indicates the data length of payload 343.

Transmit-receive time 350 is the time at which P2P wireless data 331 is received from another node 100 and the time at which P2P wireless data 331 is transmitted to another node 100. Node ID 351 and data 352 are node ID 337 and data. 338 that had been stored as payload 333 in the received P2P wireless data 331 (refer to FIG. 5).

That is node information 349 is presence information of each wireless terminal 100. Payload 343, which is constituted by the presence information of each wireless terminal 100, is the accompanying information of ad-hoc network 260.

By output data 341 being transmitted to infra-network 220 side, the accompanying information of node 100 in each ad-hoc network 260 (including those not illustrated) is collected in server 230.

Node 100, which generates output data 341, may have, for example, a GPS (global positioning system) signal receiving section (not shown) and may obtain GPS data (latitude, and longitude information). That node 100 may further store the latest GPS data obtained in payload 343 of output data 341 as the position information (of ad-hoc network 260) of node 100. Such position information may be stored in data 352 (that is, payload 333 of P2P wireless data 331) of each node information 349.

In the present embodiment, the transmit-receive time is the starting time of a super-frame (that is, an active period) in which P2P wireless data 331 is transmitted or received. The transmit-receive time may be the starting time of a corresponding time slot or another time within a frame, such as the starting time of a frame.

The description of infra-communication 270 in the present embodiment has been provided thus far.

Next, the confirmation of node 100 will be described.

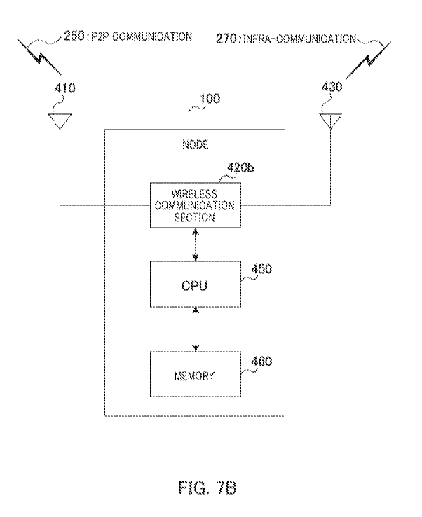

FIG. 7A is a drawing showing an example of the hardware configuration of node 100.

In FIG. 7A, node 100 has P2P communication antenna 410, wireless section 420, infra-communication antenna 430 communication section 440, CPU 450, and memory 46a.

Wireless section 420 receives control from CPU 450 and performs P2P communication 250 via P2P communication antenna 410.

Communication section 440 receives control from CPU 450 and performs infra-communication 270 via infra-communication antenna 430.

Memory 460 is a storage medium that stores a control program and the like executed by CPU 450 to control wireless section 420 and communication section 440. Memory 460 is a RAM, for example.

That is, the operation of wireless section 420 and communication section 440 is controlled by the same CPU 450. Therefore, node 100 cannot perform transmission processing using P2P communication 250 and transmission processing using infra-communication 270, simultaneously. The frequency bands of P2P communication 250 and infra-communication 270 may be the same or may be different.

In the hardware configuration, as shown in FIG. 7B, a configuration that can be envisioned is one in which wireless section 420 and communication section 140 are mounted on the same medium, for example, with a communication device constituted by a single chip. In such cases, wireless communication section 420b having the functions of both wireless section 420 and communication section 110 may be provided, and wireless communication section 420b may perform P2P communication 250 and infra-communication 270. In FIG. 7B, although the illustration is of a configuration in which P2P communication antenna 410 and infra-communication antenna 430 are different antennas, a single antenna may be shared, thereby reducing the terminal cost.

By this type of hardware configuration, node 100 can implement the functional parts described below.

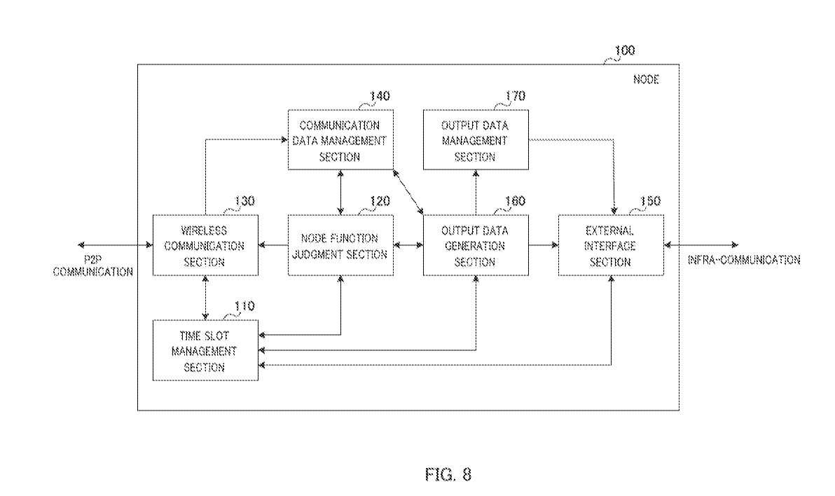

FIG. 8 is a block diagram showing an example of the functional configuration of node 100.

In FIG. 8, node 100 has time slot management section 110, node function judgment section 120, wireless communication section 130, communication data management section 140, external interface section 150, output data generation section 160, and output data management section 170.

Time slot management section 110 manages the frames and time slots described in FIG. 3 and FIG. 4. More specifically, time slot management section 110 performs overall timer management of node 100, including the schedule of P2P wireless communication with another nearby node (frame interval, time slot interval). Time slot management section 110, by timer management, controls the timing of the start of processing by wireless communication section 130, node function judgment section 120, output data generation section 160, and external interface section 150.

Node function judgment section 120, with regard to each frame 311 (refer to FIG. 3) determines the representative terminal of a plurality of nodes 100 constituting an ad-hoc network (in the example of FIG. 2, first to third nodes 100-1 to 100-3). More specifically, node function judgment section 120 minimally determines what node will be the next name representative terminal, and performs judgment as to whether or not in the current name its own node is the representative terminal. The result of determining the representative terminal is notified to wireless communication section 130, and the result of the judgment as to whether its own node is the representative terminal is notified to output data generation section 160. The representative terminal will be referred to below as either “representative node” or “node that is representative.”

Wireless communication section 130 performs the above-described P2P communication 250 in a time section in which its own node is not the representative terminal. More specifically, wireless communication section 130, in accordance with a time schedule managed by time slot management section 110, performs P2P communication 250 with a nearby terminal in a frame in which its own node is not the representative node. Then, wireless communication section 130 stores received data of P2P communication data 331 received from another node into communication data management section 140. However, even in the next frame, if its own node is not the representative node, communication data management section 140 stores received data from the representative node in the next time section (frame) (hereinafter “next time section representative node”) in a condition that distinguishes it from others.

In this case the received data refers to node ID 337 and data 338, which are stored in payload 333 of P2P wireless data 331 received by node 100. In the following description, transmission data refers to node ID 337 and data 338, which are stored in payload 333 of P2P wireless data 331 transmitted by node 100.

Communication data management section 140 stores for each frame a communication history that is a history of P2P communication 250 and representative terminal information indicating, by each frame, which node 100 was the representative node. More specifically, communication data management section 140 stores a communication history data table and representative node data. Communication data management section 140, by the communication history data table, manages the received data and receiving time from another node 100 and the transmitted data, and transmission time of P2P communication 250 transmitted by its own node. Representative node data includes data of P2P communication received from the next time section representative node and the time of reception.

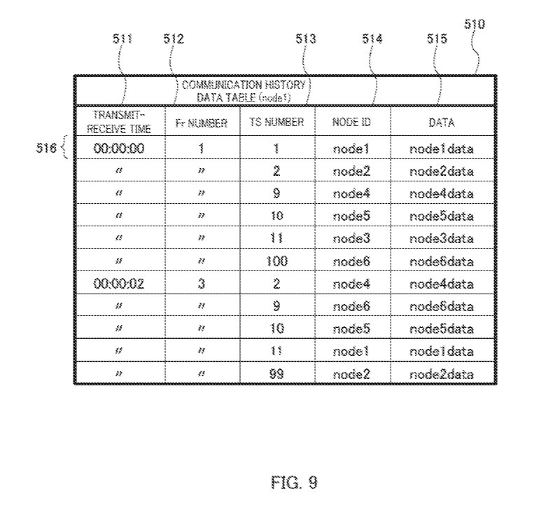

FIG. 9 is a drawing showing an example of the configuration and contents of a communication history data table. In this case the communication history data table stored in the first node (node 1) 100-1 is taken as an example. As shown in FIG. 9, a plurality of records 516 constituted by transmit-receive time 511, frame (Fr) number 512, time slot (TS) number 513 node ID 514, and data 515 are described in communication history data table 510.

Transmit-receive time 511 indicates the time of transmission of P2P wireless data transmitted by first node 100-1 and the time of reception of P2P wireless data received by first node 100-1. Frame (Fr) number 512 indicates the number of a frame in which transmission and reception of that P2P wireless data is performed. Time slot number 513 indicates the number of the time slot in which transmission and reception of that P2P wireless data is performed. Node ID 514 and data 515 are the node ID 337 and data 338 stored in that P2P wireless data 331 (refer to FIG. 5).

For example, transmit-receive time 511 of “00:00:00” and frame number 512 of “1” are associated and described in communication history data table 510. This indicates that the active period in frame number 1 starts at “00:00:00.”

Also, for example, node ID 514 of “node1” with respect to the combination of frame number 512 of “1” and time slot number 513 of “1” is associated therewith and described in communication history data table 510. Additionally, data 515 of “node1data” with respect to node ID 514 of “node1” is described in communication history data table 510. This indicates that first node (node1) 100-1 has transmitted data “node1data” by P2P communication 250 in the time slot having the time slot number “1” of a frame of frame number “1.”

Also, for example, node ID 514 of “node 2” with respect to a combination of frame number 512 of “1” and time slot 513 of “2” is described in communication history data table 510. Additionally, data 515 of “node2data” with respect to node ID 514 of “node2 is described in communication history data table 510. This indicates that second node (node2) 100-2 has received data “node2data” by P2P communication 250 in the time slot having the time slot number “2” of a frame of frame number “1.”

That is, each record 516 is presence information of each node 100 of ad-hoc network 260. Although it will be described later, the representative node presence information is described in the representative node data.

Data 338 may be the actual data, or may be information indicating data itself that is stored in a separate location.

Although it will be described later, time slot number 513 is used when node function judgment section 120 determines the representative node. Transmit-receive time 511, node ID 514, and data 515 are used as node information 349 (FIG. 6) of output data 341.

Although record 516 is described regarding a plurality of frames in communication history data table 510 of FIG. 9, record 516 may be described for only the most recent frame at any time, as will be described later. This enables a reduction of the memory capacity required by node 100. The individual records will be called the “communication history data” as appropriate.

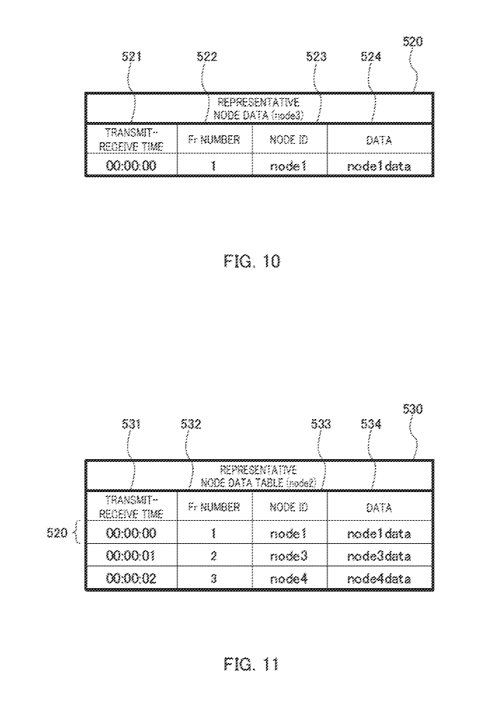

FIG. 10 is a drawing showing an example of the configuration and the contents of representative node data. In this case, a communication history data table stored in third node (node3) 100-3 is taken as an example.

As shown in FIG. 10, transmit-receive time 521, frame (Fr) number 522, node ID 521, and data 524 are described in representative node data 520. Transmit-receive time 521, frame number 522, node ID 523, and data 524 correspond to transmit-receive time 511, frame number 512, node ID 514, and data 515 of communication history data table 510. However, representative node data 520 is information regarding P2P wireless data received from the representative node of the current frame in the immediately previous frame.

That is, representative node data 520 is presence information of the next time section representative node in the immediately previous flame.

Communication data management section 140, rather than storing only representative node data 520 with regard to one frame, may store a representative node data table that is a list of representative node data 520 with regard to a plurality of frames.

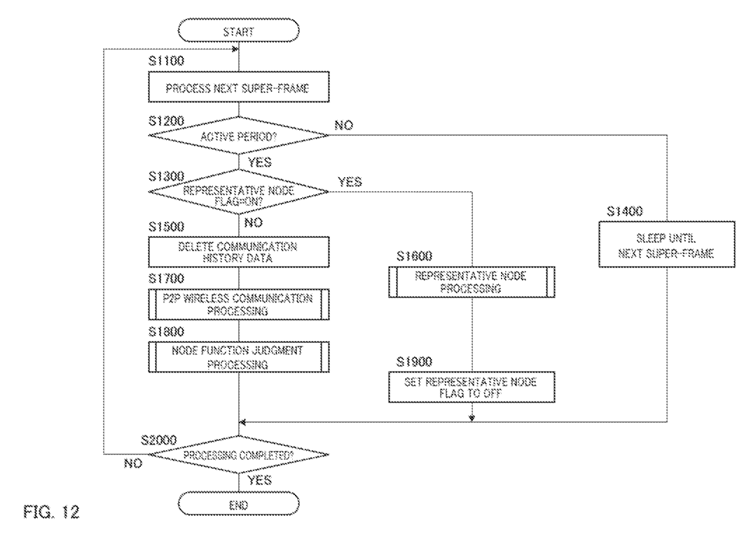

FIG. 11 is a drawing showing an example of the configuration and contents of a representative node data table, which corresponds to FIG. 10. Parts corresponding to those in FIG. 10 are assigned the same reference signs, and the descriptions thereof will be omitted. In this case, the representative node data table stored in second node (node2) 100-2 is taken as an example.

As shown in FIG. 11, a plurality of representative node data. 520 constituted by transmit-receive time 531, frame number 532, node ID 533, and data 534 are described in representative node data table 530.

External interface section 150 of FIG. 8 performs infra-communication 270 described above. More specifically, external interface section 150, in accordance with a time schedule that is managed by time slot management section 110, transmits output data in a frame in which its own node is the representative node.

In a frame in which its own node is the representative node, output data generation section 160, using external interface 150 transmits a communication history and representative terminal information in association with each other and stored in communication data management section 140 to the network.

More specifically, output data generation section 160 extracts a set of transmit-receive time 511, node ID 514, and data 515 from record 516 of a frame that is immediately previous in communication history data table 510. The set of extracted information is presence information of the previous frame of node 100 other than the representative node. Output data generation section 160 also extracts from representative node data 520 a set of transmit-receive time 521, node ID 523, and data 524. The extracted set of information is presence information of the representative node of the immediately previous frame.

Output data generation section 160 combines the extracted presence information of node 100 other than the representative node and presence information of the representative node and generates, and transmits output data 341 as payload 343 (refer to FIG. 6). That is, output data generation section 160 sends, to infra-network 220, information generated by combining the presence information of node 100 other than the representative node and presence information of the representative node, as the overall accompanying information of ad-hoc network 260 of the immediately previous frame.

Output data generation section 160 outputs to output data management section 170 data that is the same as the transmitted output data 341.

Output data management section 170 temporarily stores and manages output data that has been transmitted to the external network by output data generation section 160.

Of nodes 100 such as this, for each frame, a node other than the representative node can perform P2P communication, and a representative node can transmit a communication history all together to server 230 as accompanying information.

By doing this, node 100 can avoid an increase in the CPU occupation rate for processing for external communication in the overall ad-hoc network 260 to a low level. Node 100 can make the P2P communication time in the overall ad-hoc network 260 commensurately longer, and can more reliably acquire presence information of other nodes 100 as a communication history.

However, in the time section in which a node becomes a representative node, P2P communication 250 is not performed. For this reason, another node 100 cannot obtain the presence information of the representative node from the communication history of that section. The presence information of the representative node of that section is stored in communication history of P2P communication 250 in a past time section. Another node 100, by associating representative node data of that time section obtained from a past communication history with the communication history of P2P communication 250 in that time section, can generate presence information of all nearby nodes 100, including the representative node.

That is, node 100 can prevent the drop-out of presence information of the representative node while preventing drop-outs of presence information of nodes other than the representative node. Therefore, node 100 can transmit accompanying information of ad-hoc network 260 to server 230 while reducing drop-outs.

The description of the configuration of node 100 has been given thus far.

Next, the operation of node 100 will be described.

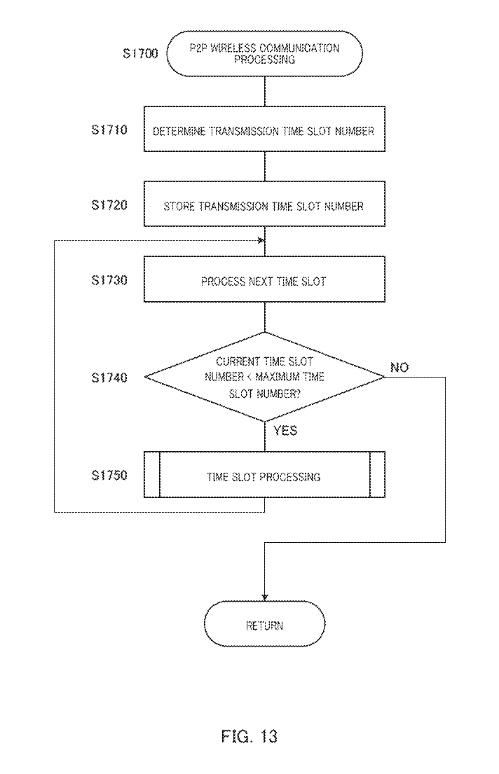

FIG. 12 is a flowchart showing an example of the operation of node 100.

First, at step S1100, wireless communication section 130 waits for the timing of the start of the next super-frame, and then starts processing.

Then, at step S1200, wireless communication section 130 judges whether or not the next super-frame (hereinafter “current super-frame”) is the active period. If the current super-frame is the active period (YES at S1200), processing of wireless communication section 130 proceeds to step S1300. If the current super-frame is not the active period (NO at S1200), processing thereof proceeds to step S1400.

At step S1300, node function judgment section 120 judges whether or not the representative node flag is on. If the representative node flag is off (NO at S1300), node function judgment section 120 proceeds to step S1500. If node function judgment section 120 judges the representative node flag to be on (YES at S1300), processing proceeds to step S1600.

In this case, the representative node flag is information indicating whether or not its own node is the representative node in each frame, this being managed, for example, by node function judgment section 120. If the representative node flag is on, in current frame its own node is the representative node, and if the representative node flag is off, in the current frame its own node is not the representative node. Whether or not each node is a representative node is, as will be described later, determined based on the slot number.

At step S1500, node function judgment section 120 deletes the contents of the communication history data stored at the current time with respect to communication data management section 140. This is because, since its own node is not the representative node it does not need to hold past communication history data.

Then, at step S1700, wireless communication section 130 performs P2P wireless communication processing so as to collect presence information of other nodes. Details of P2P communication will be described later.

Then, at step S1800, if its own node is the representative node of the next time section, node function judgment section 120 switches the representative node flag to on by performing node function judgment processing. Details of the node function judgment processing will be described later.

At step S1600, by performing representative node processing, output data generation section 160 transmits accompanying information of ad-hoc network 260 to server 230. The details of the representative node processing will be described later.

At step S1900, node function judgment section 120 switches the representative node flag to off.

At step S1400, wireless communication section 130 sleeps until the next super-frame.

At step S2000, wireless communication section 130 judges whether or not the end of processing of collection or transmission of accompanying information has been instructed by a user operation or the like. If the end of the processing has not been instructed (NO at S2000) processing of wireless communication section 130 proceeds to step S1100. If the end of processing has been instructed (YES at S2000) wireless communication 130 ends the sequence of processing.

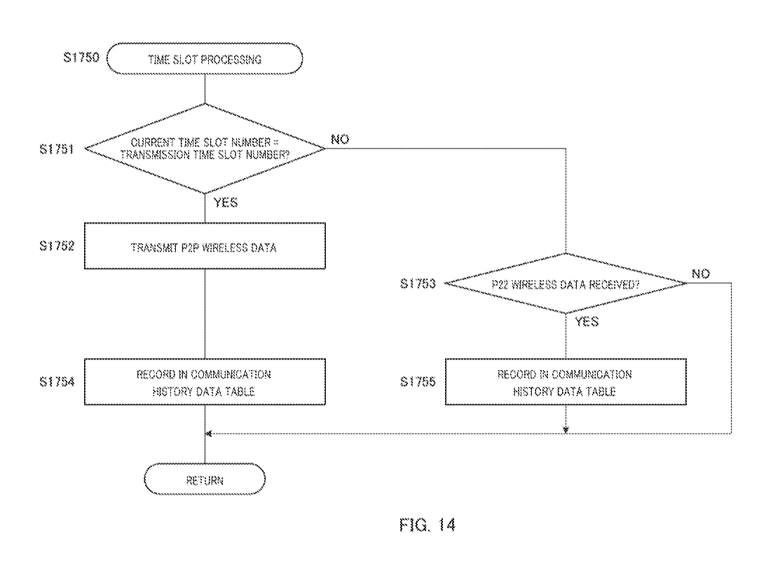

FIG. 13 is a flowchart showing an example of P2P wireless communication processing (S1700).

First, at step S1710, wireless communication section 130 determines the time slot number (hereinafter, “transmission time slot number”) used by its own node for P2P wireless data transmission. For example, wireless communication section 130 determines the transmission time slot number from time slot numbers of super-frames by selecting one at random.

Then, at step S1720, wireless communication section 130 stores the determined transmission time slot number.

At step S1730, wireless communication section 130 waits for the timing of the start of the next time slot, and then starts processing.

At step S1740, wireless communication section 130 judges whether or not the current time slot number is smaller than the maximum time slot number. The current time slot number is the number of the current time slot. The maximum time slot number is the maximum value of the time slot numbers of the super-frames. If the wireless communication section 130 judges that current time slot member is smaller than the maximum time slot number (YES at S1740), processing proceeds to S1750.

At step S1750, by its own node performing time slot processing, wireless data is transmitted and received. The details of the time slot processing will be described later.

If the wireless communication section 130 judges that the current time slot number has readied the maximum time slot number (NO at S1740), return is made to the processing of FIG. 12.

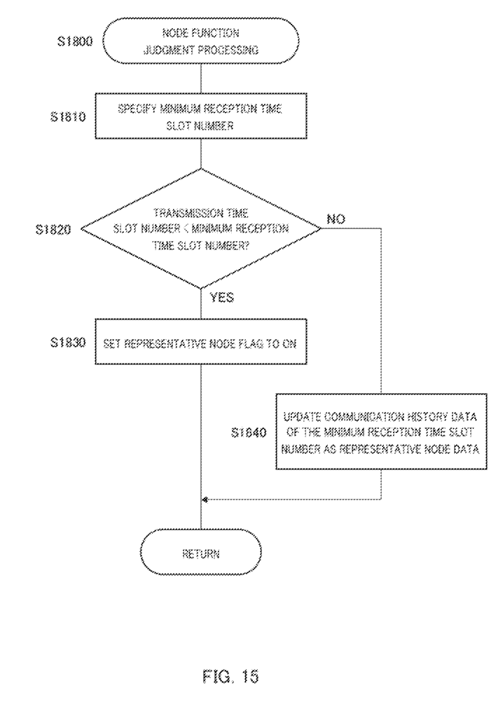

FIG. 14 is a flowchart showing an example of the time slot processing (S1750).

First, at step S1751 wireless communication section 130 judges whether or not the current time slot number coincides with the transmission time slot number. If wireless communication section 130 judges that the current time slot number coincides with the transmission time slot number (YES at S1751), processing proceeds to step S1752. If wireless communication section 130 judges that the current time slot number does not coincide with the transmission time slot number (NO at S1751), processing proceeds to step S1753.

At step S1752, wireless communication section 130 transmits P2P wireless data.

At step S1754, wireless communication section 130 transmits P2P wireless data to communication data management section 140 and causes it to be recorded in communication history data table 510 (refer to FIG. 9), after which return is made to the processing of FIG. 13.

At step S1753, wireless communication section 130 waits for reception of P2P wireless data from another node and judges whether or not the P2P wireless data has been received before the end of the current time slot. If wireless communication section 130 judges that P2P wireless data has been received (YES at S1753), processing proceeds to step S1755. If wireless communication section 130 judges that P2P wireless data has not been received (NO at S1753), processing proceeds as is to the processing of FIG. 13.

At step S1755, wireless communication section 130 receives P2P wireless data and causes wireless data management section 140 to record it in communication history data table 510 (refer to FIG. 9), after which return is made to the processing of FIG. 13.

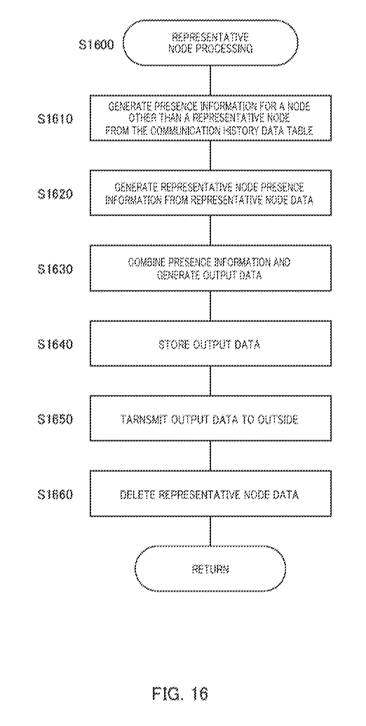

FIG. 15 is a flowchart showing an example of node function judgment processing (S1800).

First, at step S1810, node function judgment section 120 identifies the minimum reception time slot number. The minimum reception time slot number is the minimum value of the time slot number in which wireless communication section 130 has received P2P wireless data in the current super-frame. For example, node function judgment section 120 may identify the minimum reception time slot number based on the result of monitoring reception by the wireless communication section 130, or may identify the minimum reception time slot number by referencing the communication history data table of communication data management section 140.

At step S1820, node function judgment section 120 judges whether or not the transmission time slot number in the current super-frame is smaller than the identified minimum reception time slot number. That is, node function judgment section 120 judges whether or not its own node has first transmitted P2P wireless data in ad-hoc network 260. If the node function judgment section 120 judges that the transmission time slot number is smaller than the minimum reception time slot number (YES at S1820), processing proceeds to step S1830. If node function judgment section 120 judges that the transmission slot number is at least the minimum reception time slot number (NO at S1820), processing proceeds to step S1840.

At step S1830, node function judgment section 120 judges that the local number is the next time section representative node and switches the representative node flag to on, after which return is made to the processing of FIG. 12.

At step S1840, node function judgment section 120 updates the P2P wireless data communication history data received in the minimum reception time slot number as representative node data 520 (refer to FIG. 10). That is, node function judgment section 120, of the records of the communication history data, generates the representative node data from the record of the time slot having the minimum time slot number. Node function judgment section 120 then returns to the processing of FIG. 12.

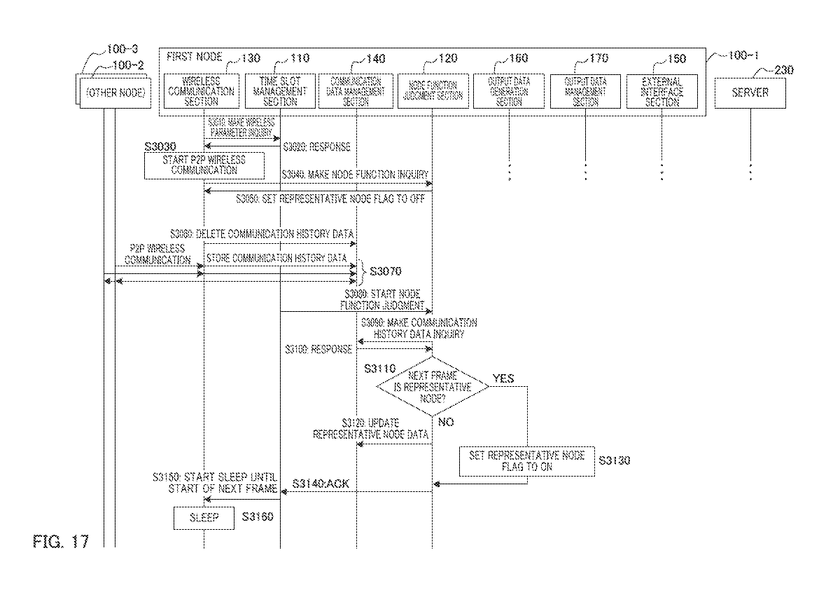

FIG. 16 is a flowchart showing an example of representative node processing (S1600).

First, at step S1610, output data generation section 160 generates presence information for nodes other than the representative node, from communication history data table 510 (refer to FIG. 9) stored by communication data management section 140. That is, output data generation section 160 obtains a set of transmit-receive time 511, node ID 514, and data 515 as one node information 349 of output data 341 (refer to FIG. 6) from each record of the immediately previous frame.

Then, at step S1620, output data generation section 160 generates presence information of the representative node from representative node data 520 (refer to FIG. 10) stored by communication data management section 140. That is, output data generation section 160 obtains a set of transmit-receive time 531, node ID 533, and data 534 from representative node data 520 that is received and recorded two frames ago as one node information 349 of output data 341 (refer to FIG. 6).

At step S1630, output data generation section 160 combines the obtained presence information of the nodes other than the representative node and the presence information of the representative node and generates output data 341 in which the combined data is taken as payload 343 (refer to FIG. 6).

At step S1640, output data generation section 160 causes storage of the generated output data 341 in output data management section 170.

At step S1650, output data generation section 160 transmits the generated output data 341 to outside, via external interface section 150. That is, output data generation 160 transmits accompanying information of ad-hoc network 260 to server 230.

At step S1660, output data generation 160 deletes representative node data 520 which was the subject of transmission in communication data management section 140, and returns to the processing of FIG. 12.

By this kind of operation, node 100, for each frame, performs P2P communication 250 when the node itself is not the representative node, and transmits accompanying information to server 230 without performing P2P communication 250 when the node itself is the representative node. When this is done, node 100 can transmit accompanying information that includes presence information of the representative node for the immediately previous flame to server 230. Repeating this type of operation makes it possible to transmit accompanying, information of ad-hoc network 260 to server 230 while reducing drop-outs.

The description of the operation of node 100 has been given thus far.

Next, a specific example of the flu of operation of each functional part in a given node 100 in a given active period super-frame will be described.

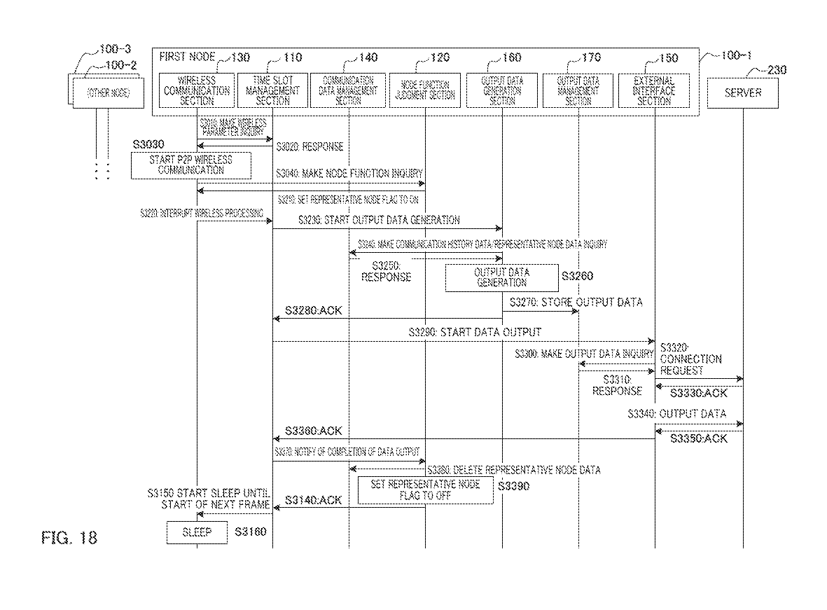

FIG. 17 is a sequence diagram showing an example of the operational flow of each functional part of a first node 100-1 for the case in which the first node 100-1 is not a representative node.

First, wireless communication section 130 makes a wireless parameter inquiry with respect to time slot management section 110 (S3010), and upon reception of notification of the start of the active period as a response (S3020), wireless communication section 130 starts P2P communication 250 (S3030). Wireless communication section 130 makes a node function inquiry with respect to node function judgment section 120 (S3040) and receives a response to the effect that the representative node flag is off (S3050).

Wireless communication section 130, after deleting the communication history data (S3060) performs P2P wireless communication with second and third nodes 100-2 and 100-3, and causes the communication history data thereof to be stored in communication data management section 140 (S3070).

Node function judgment section 120 receives an instruction from time slot management section 110 and starts the node function judgment (S3080). Node function judgment section 120 makes a communication history data inquiry with respect to communication data management section 140 (S3090), and obtains as a response, the transmission time slot number and communication history data table (S3100). Node function judgment section 120, from the obtained communication history data table, identifies the minimum time slot number and compares it with the received transmission time slot number. As a result, if first node 100-1 is not the next time section representative node (NO at S3110), node function judgment section 120 causes communication data management section 140 to update the representative node data (S3120). If first node 100-1 is judged by node function judgment section 120 to be the next time section representative node (YES at S3110), it switches the representative node flag to on (S3130).

When time slot management section 110 receives from node function judgment section 120 ACK (acknowledgement) with respect to the above-described instruction (S3140), it causes wireless communication section 130 to sleep until the start of the next frame (S3150). As a result, wireless communication section 130 is in the sleep status until the start of the next frame (S3160).

In this manner, the first node 100-1, if the node itself is not the representative node, stores the communication history with second and third nodes 100-2 and 100-3, and further, if the node itself is the next time section representative node, switches the representative node flag to on.

In actuality, one of first to third nodes 100-1 to 100-03 is the representative node. Therefore, the first node 100-1 performs transmission and reception of P2P wireless data with only one of the second and third nodes 100-2 and 100-3.

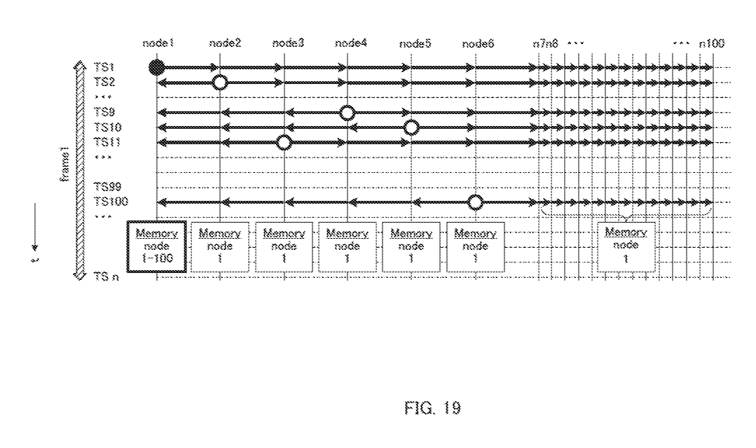

FIG. 18 is a sequence diagram showing an example of the operational flow of each functional part in the first node 100-1, which corresponds to FIG. 17. Parts that correspond to those in FIG. 17 are assigned the same step numbers, and the descriptions thereof will be omitted.

Node function judgment section 120, with respect to an inquiry from wireless communication section 130, responds to the effect that the representative node flag, is on (S3210). In this case, time slot management section 110 receives from wireless communication section 130 a notification of the interruption of wireless processing (S3220) and instructs output data generation section 160 to start output data generation (S3230).

When this occurs, output data generation section 160 makes a communication history data and representative node data inquiry (S3240) with respect to communication data management section 140, receives a response thereto (S3250) and generates output data (S3260). Output data generation section 160 then causes the generated output data to be stored in output data management section 170 (S3270). After that, time slot management section 110 receives from output data generation section 160 ACK with respect to the above-described instruction (S3280) and instructs external interface section 150 to start the output of data (S3290).

External interface 150 makes an output data inquiry with respect to output data management section 170 (S3300), obtains the output data as a response thereto (S3310), and makes a connection request with respect to server 230 (S3320). Then, when external interface section 150 receives ACK from server 230 (S3330), and outputs (transmits) the obtained output data to server 230 (S3340). When external interface section 150 receives ACK from server 230 (S3350), it outputs to time slot management section 110 ACK with respect to the above-described data output instruction (S3360).

After that, when node function judgment section 120 receives from time slot management section 110 notification of the end of data output (S3370), it causes communication data management section 140 to delete the representative node data (S3380). Then, node function judgment section 120 switches the representative node flag to of (S3390).

in this manner, when the first node 100-1 itself is the representative node, it transmits the accompanying information obtained from the communication history data and representative node data to server 230 without performing P2P communication 250, and switches the representative node flag to off.

The above completes the description of a specific example of the operational flow in each functional part in node 100.

Next, how the representative node is exchanged in ad-hoc network 260 will be described.

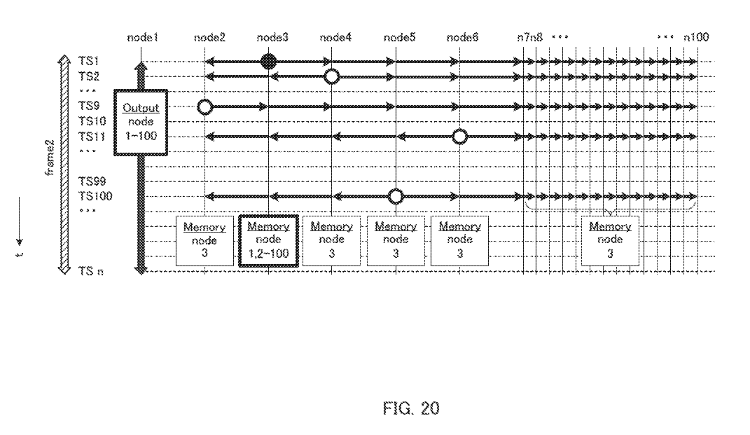

FIG. 19 to FIG. 21 are drawings that show how the representative node is exchanged and how the status of the information (communication history data and representative node data) stored by each node 100 changes.

In this case, an example is shown in which a given ad-hoc network is formed by 100 nodes 100 (node1 to node100).

As shown in FIG. 19, in the first frame (frame1), the first node (node1), as a result of randomly selecting a transmission slot, first transmits P2P wireless data. In this case, the first node (node1) is the next time section representative node.

Then, as a result, the first node holds at least the communication history of the first to 100th node 100 as communication history data (Memory node1 to 100) until the transmission of output data in the second frame is completed.

In contrast, other nodes 100 hold at least the first node representative terminal information for the first node, which is the next time section representative node as representative node data (Memory node1) until the transmission of output data in the second frame is completed.

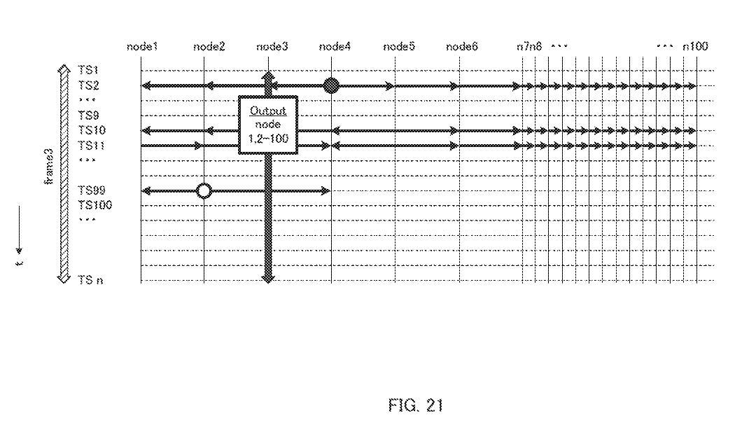

As shown in FIG. 20, in the second frame (frame2), the third node (node1), which is the representative node outputs the communication history of the first to 100th nodes 100 as accompanying information of ad-hoc network 260 (Output node1-100). The first node does not perform P2P communication 250 in the second frame.

As shown in FIG. 20, in the second frame (frame2), the third node (node3) as a result of random selection of the transmission slot, first performs transmission of P2P wireless data. In this case the third node (node3) becomes the representative node of the next time section.

As a result, until the completion of transmission of output data in the third frame, at least the second to 100th nodes 100 hold the communication history as the communication history data (Memory node2-node100). The reason the first node (node1) is not included in the communication history is that the first node does not perform P2P communication 250 in the second frame. However, until the completion of transmission of the output data in the third frame, the third node holds representative node information of the first node 100 in the first frame as representative node data (Memory node1).

In contrast, until the completion of transmission of output data in the third frame, nodes 100 other than the representative node hold at least the representative terminal information of the third node, which is the representative node, as representative node data (Memory node3).

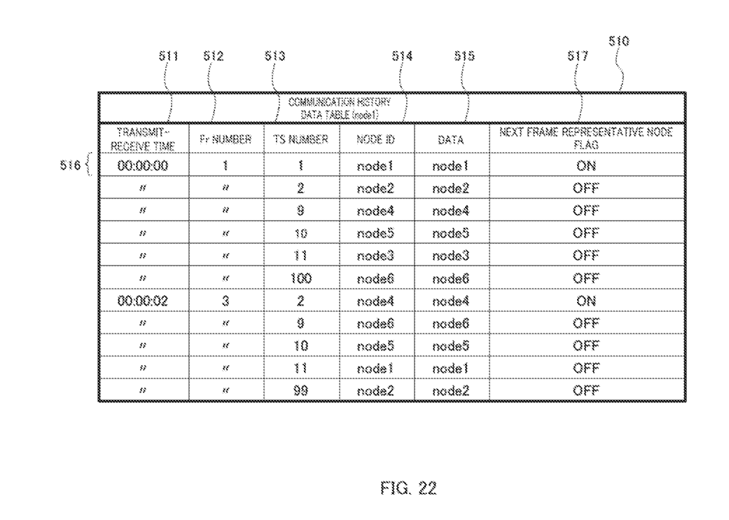

As shown in FIG. 21, in the third frame (frame3) the third node (node3), which is the representative node, merges the representative terminal information of the first node 100 with the communication history of the second to the 100th nodes 100. The third node outputs the merged data as accompanying information of ad-hoc network 260 (Output node1, 2-100). In the third frame, the third node does not perform P2P communication 250.

As shown in FIG. 21, in the third flame (frame3) the fourth node (node4) first transmits the PSP wireless data as the results of random selection of a transmission slot. As a result, the fourth node (node4) becomes the next time section representative node.

In this manner, the representative node is randomly exchanged for each frame, and the representative node for each frame is in a state where the node has stored the presence information for all nodes 100 of ad-hoc network 260. As a result, in ad-hoc network 260, the accompanying information of all nodes therein can be transmitted to server 230.

The above completes the description of the situation of exchanging the representative nodes in ad-hoc network 260.

As described above, when node 100 according to the present embodiment is not itself the representative, node, it performs P2P communication 250 and stores the communication history and representative terminal information beforehand. When node 100 according to the present embodiment is itself the representative node, it transmits the communication history and representative terminal information to the external network. By doing this, node 100 can transmit accompanying information of the ad-hoc network to the external network while reducing drop-outs.

In the present embodiment, although node 100 that is a representative node is configured to combine and transmit accompanying information obtained from the communication history data and accompanying information obtained from the representative node data without distinction therebetween, this is not a restriction. Node 100 may generate and transmit output data to which information has been added so as to distinguish between the pieces of accompanying information, and may transmit these output data separately. Accompanying information obtained from representative node data is information from the frame immediately before the accompanying information obtained from the communication history data. Therefore, node 100, by transmitting these to server 230 in a condition enabling distinguishing therebetween, can cause an improvement in the accuracy of analysis of the accompanying information at server 230.

The form of storage of the communication history and the representative terminal information is not restricted to the above-described example. The above-described representative node data is a communication history of the representative node. Therefore, for example, node 100, rather than preparing representative node data separately, may indicate, in a communication history data table, information indicating which record is the record of the next time section representative node.

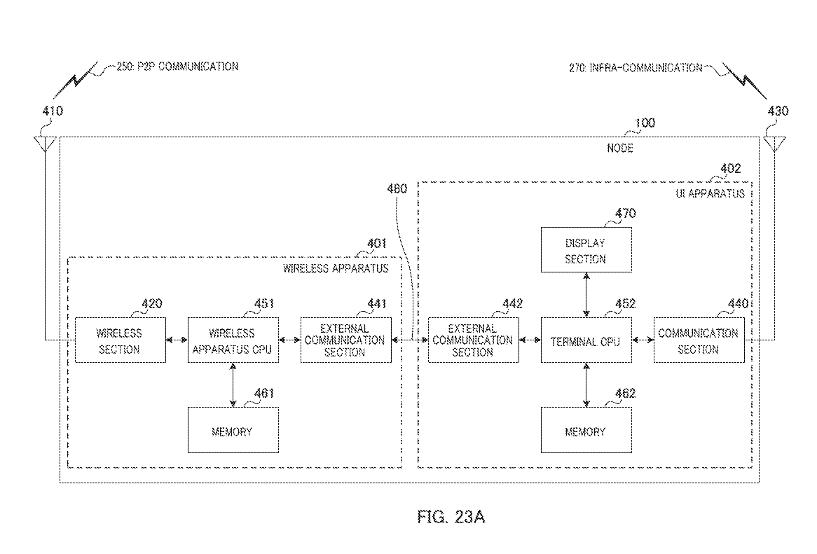

FIG. 22 is a thawing showing another example of the configuration and contents of the communication history data table, this corresponding to FIG. 9. Parts that are the same as those in FIG. 9 are assigned the same reference signs, and the descriptions thereof will be omitted.

As shown in FIG. 22, communication history data table 510 has described therein the next time section representative node flag 517 for each record 516. For example, in communication history data table 510, of records 516 corresponding to frame number 512 of “1,” in a record 516 in which node ID 514 of “node1” is described, the next time section representative node 517 of “ON” is described. Also, in communication history data table 510, of the records 516 corresponding to frame number 512 of “1,” in other records 516, next time section representative node 517 of “OFF” is described. This indicates that, in the next frame (that is, the frame with the frame number “2”) having the frame number of “1,” on the first node 100-1 (node1) is a representative node.

When using communication history data table 510 as shown in FIG. 22, node 100 may manage its own representative node flag by this communication history data table 510.

Also, in the case in which node 100 does not use representative node data and uses communication history data table 510 as shown in FIG. 22, it is necessary to describe, in communication history data table 510, at least the record of the immediately previous name and the record two frames ago. In this case, node 100 can transmit all records for the immediately previous frame and the records for which next time section representative node flag 517 is ON two frames ago to server 230 as accompanying information.

The hardware configuration of node 100 is not restricted to the examples described above.

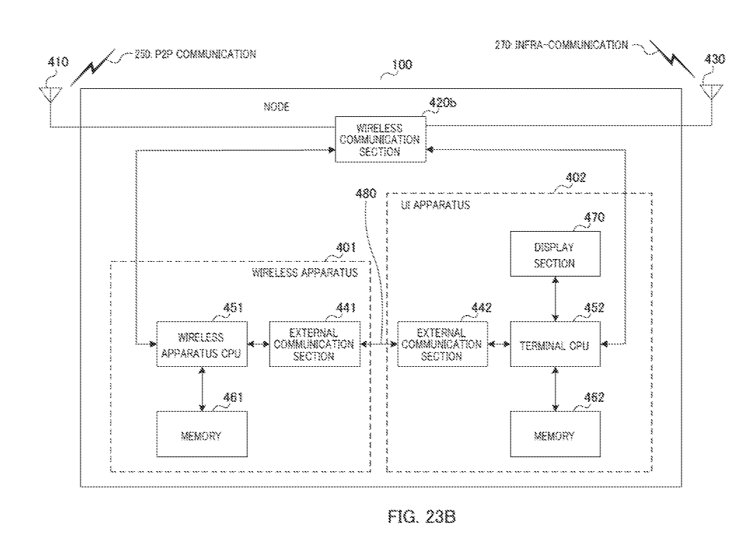

FIG. 23A is a drawing showing another example of the hardware configuration of node 100, this corresponding to FIG. 7A. Parts that are the same as those in FIG. 7A are assigned the same reference signs, and the descriptions thereof will be omitted.

In FIG. 23A, node 100 has wireless apparatus 401 and UI apparatus 402, which are functional parts for performing P2P communication 250.

Wireless apparatus 401 has P2P communication antenna 410, wireless section 420, external communication section 441, CPU 451 of the wireless apparatus, and memory 461. UI apparatus 402 has infra-communication antenna 430, communication section 110, external communication section 442, display section 470, CPU 452 of the terminal, and memory 462.

Wireless section 420 and external communication section 441 of wireless apparatus 401 receive control from CPU 451 of the wireless apparatus, perform P2P communication 250, and perform serial communication 480 with external communication section 112 of UI apparatus 402.

Memory 461 is a storage medium, such as a RAM, that stores a control program or the like that is executed by CPU 451 of the wireless apparatus to control wireless section 420 and external communication section 441.

Communication section 440 and external communication section 442 of UI apparatus 402 receive control from CPU 452 of the terminal, perform infra-communication 270, and perform serial communication 480 with external communication section 441 of wireless apparatus 401.

Display section 470 of UI apparatus 402 has, for example, a liquid-crystal display and performs display and the like of a graphical user interface.

Memory 462 is a storage medium, such as a RAM, that stores a control program and the like that is executed by CPU 452 of terminal to control communication section 440, external communication section 442, and display section 470.

In this case, external communication section 441 of wireless apparatus 401, external communication section 442, CPU 452 of the terminal, communication section 440 of UI apparatus 402, and infra-communication antenna 430 correspond to external interface 150 of FIG. 8. The operation of both wireless section 420 and external communication section 441 of wireless apparatus 401 is controlled by CPU 451 of the wireless apparatus. For this reason, in a frame in which transmission processing of P2P communication 250 is performed, node 100 having a configuration such as this cannot perform transmission processing of infra-communication 270.

In the case of such a hardware configuration, however, UI apparatus 402 can operate in the sleep mode (low power consumption mode) if there is no signal from the wireless apparatus 401. Therefore, node 100 having a hardware configuration such as this reduces the operating time of UI apparatus 402 and can achieve a great effect in reducing the power consumption in the overall ad-hoc network 260 or the overall accompanying information collection system 200.

In the hardware configuration, as shown in FIG. 23B, a configuration can be envisioned in which wireless section 420 and communication section 440 are mounted on the same medium, for example, a communication device constituted by a single chip. Iii such cases, wireless communication section 420b having the functions of both wireless section 420 and communication section 440 may be provided, and wireless communication section 420b may perform P2P communication 250 and infra-communication 270.

Although FIG. 23B illustrates an example of a configuration in which P2P communication antenna 410 and infra-communication antenna 430 are different antennas, a single antenna may be shared, thereby reducing the terminal cost.

Although FIG. 23B illustrated a configuration in which CPU 452 of the terminal and wireless communication section 420b are connected by a line, they need not be connected by a line, and the configuration may be one in which a connection line is made only of wireless apparatus 451 (constituted, for example, by MCA (media access control) processing, upper-layer processing, and API (application program interface) or the like with respect to wireless communication section 420b (constituted, for example, by baseband, RF (radio frequency, wireless signal processing), and an antenna control section or the like).

In the present embodiment, although there has been one representative node for each frame, this is not a restriction. In the case in which a large number of nodes 100 such as one hundred nodes 100 form ad-hoc network 260, the number of representative nodes for each frame may be made, for example, ten. In this case, node function judgment section 120 of each node 100, for example, extracts ten nodes 100 (including the node) that have performed transmission of P2P wireless data, in sequence from the front time slot, for each frame. Node function judgment section 120 then determines the extracted nodes 100 as the next time section representative nodes. This enables more reliable periodic (for each frame) transmission of accompanying information to server 230.

The units of time for performing P2P communication 250 or infra-communication 270 may be frame units, or alternatively may be an non-fixed time unit determined dynamically or a time section on the time axis specified by absolute times. The connected wireless base station may distribute information regarding time (scheduling) or performing P2P communication 250 and infra-communication 270 for each node, which can be used as a parameter when a node determines the representative terminal

### Embodiment 3

Embodiment 3 of the present invention is an example in which, when a node judges that it itself is a representative node, verification is made with respect to other nodes.

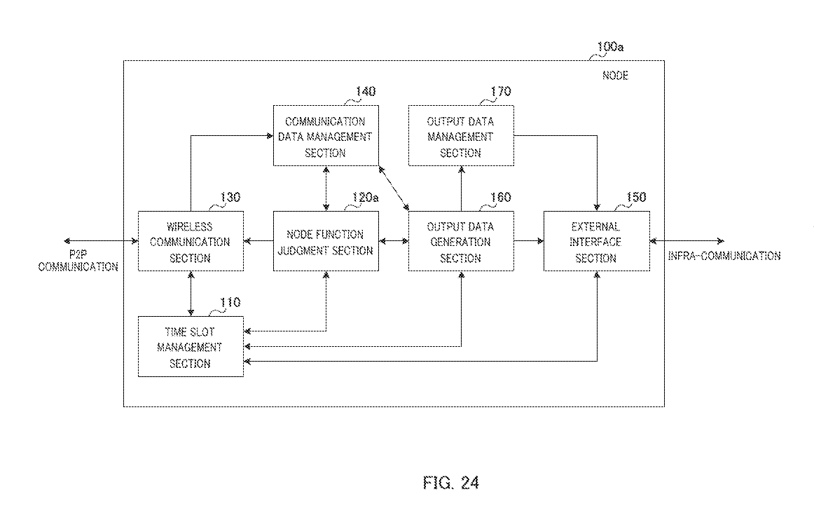

FIG. 24 is a block diagram showing an example of the functional configuration of a node according to the present embodiment, this corresponding to FIG. 8 of Embodiment 2. Parts that are the same as those in FIG. 8 are assigned the same reference signs, and the descriptions thereof will be omitted.

In FIG. 8 node 100a has node function judgment section 120a in place of node function judgment section 120 of FIG. 8.

Node function judgment section 120a transmits to another node 100a a representative node declaration that declares that its own node 100a is a representative node, and in the case in which a response thereto is received, judges that its own node is the next time section representative node. In the case in which a representative node declaration is received from another node 100a and also a response thereto is transmitted, node function judgment section 120a judges that the other node 100a is the next time section. That is, in the present embodiment, node 100a is only the next time section representative node when a response is obtained from another node 100a.

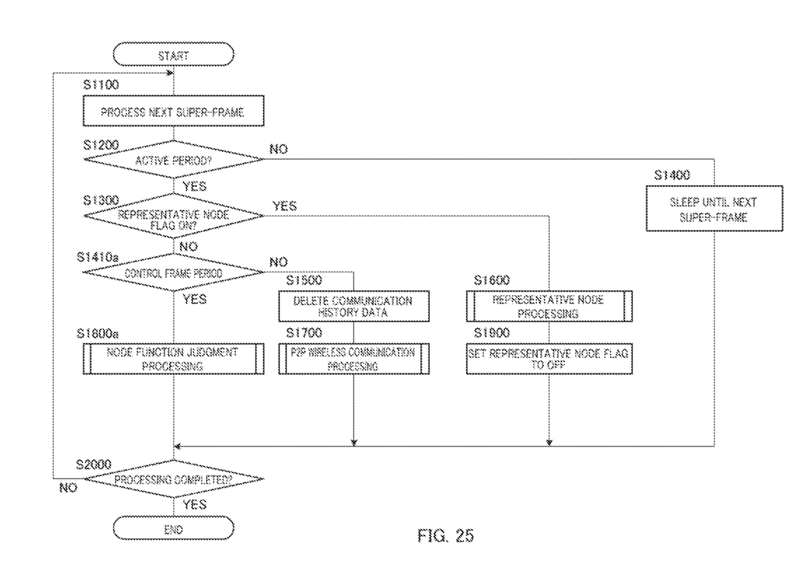

FIG. 25 is a flowchart showing an example of the overall operation of node 100a, this corresponding to FIG. 12 of Embodiment 2. Parts that are the same as those in FIG. 12 are assigned the same reference sighs, and the descriptions thereof will be omitted.

If node function judgment section 120a judges the representative node flag to be off (NO at S1300), proceeding proceeds to step S1410a.

At step S1410a, node function judgment section 120a judges whether or not it is the control frame period. The control frame period is, for example, the first super-frame in the case in which a super-frame in which P2P wireless communication is performed (active period) is the second super-frame. That is, the control frame period is, for example, taken to be a period which is set beforehand to be a time section other than a super-frame that is used for P2P wireless communication. If node function judgment section 120a judges that it is the control name period (YES at S1410a), processing proceeds to step S1800a. If node function judgment section 120a judges that it is not the control frame period (NO at S1410a), processing proceeds to step S1500. In the present embodiment, node function judgment section 120a, after step S1500, passes through step S1700, and proceeds to step S2000.

At step S1800a, node function judgment section 120a performs node function judgment processing that differs from that of Embodiment 1.

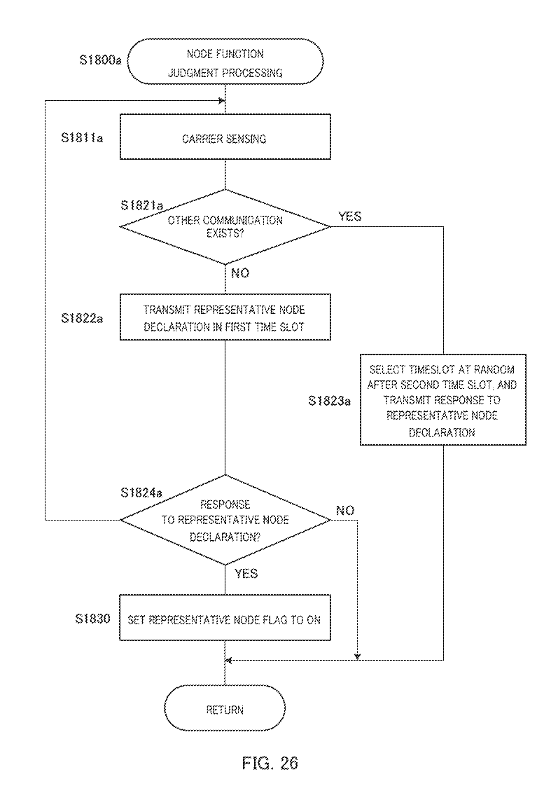

FIG. 26 is a flowchart showing an example of node function judgment processing in the present embodiment, this corresponding to FIG. 15 of Embodiment 2. Parts that are the same as those in FIG. 15 are assigned the same step numbers and the descriptions thereof will be omitted.

First, at step S1811a, node function judgment section 120a causes wireless communication section 130 to perform earlier sensing at the start of the first time slot.

At step S1821a, node function judgment section 120a judges whether or not, as a result of the carrier sensing, there is other communication (communication of another node 100a). The “other communication” as used herein includes communication of data indicating a representative node declaration, which is described later. If node function judgment section 120a judges that there is no other communication (NO at S1821a), processing proceeds to step S1822a. If node function judgment section 120a judges that there is other communication (YES at S18214 processing proceeds to step S1823a.

At step S1822a node function judgment section 120a causes wireless communication section 130 to transmit to node 100a a representative node declaration in the first time slot.

At step S1824a, node function judgment section 120a judges whether or not there has been a response to the transmitted representative node declaration. If node function judgment section 120a judges that there has been a response (YES at S1824a), processing proceeds to step S1830 and the representative node flag is switched to on. If node function judgment section 120a judges that there has been no response (NO at S1824a), return is made as is to the processing of FIG. 25.

At step S1823a node function judgment section 120a randomly selects a time slot from among the second time slot and time slots after the second time slot. Node function judgment section 120a transmits a response with respect to a representative node declaration that had been included in another communication to at least the origin of the transmission of the representative node declaration, and returns to the processing of FIG. 25.

Node 100a such as this becomes the next time section representative node only in the case in which a response is obtained from another node 100a, and in the case in which a response is not obtained, performs P2P communication 250. By doing this, even in a case, in which, at many nodes 100a, because of a factor such as the communication environment, it was not possible to detect another node 100a, that has performed the first communication, it is possible to prevent a large number of nodes 100a, becoming representative nodes. That is, it is possible to more reliably perform exchange of presence information by P2P wireless communication, and possible to reliably prevent drop-outs of accompanying information.

### Embodiment 4

Embodiment 4 of the present invention is an example in the case in which the there is an unspecified number of frames required for transmission of accompanying information.

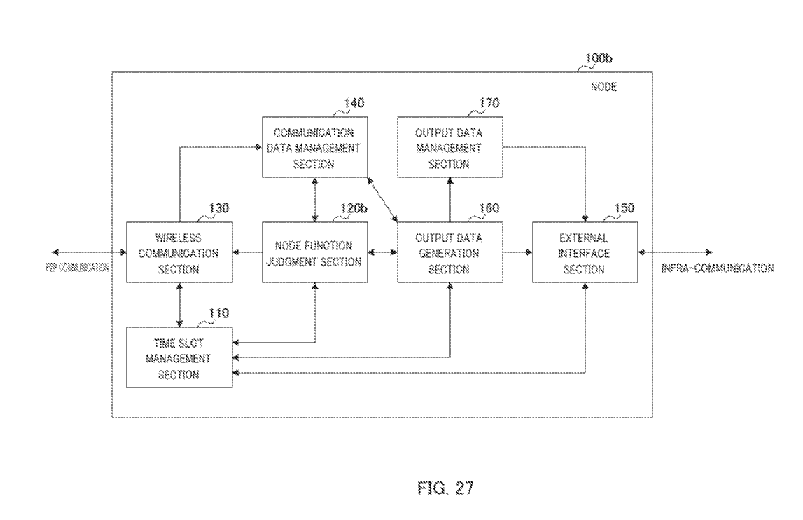

FIG. 27 is a block diagram showing an example of the functional configuration of a node according to the present embodiment, this corresponding to FIG. 8 of Embodiment 2. Parts that are the same as those in FIG. 8 are assigned the same reference signs, and the descriptions thereof will be omitted.

In FIG. 27, node 100b has node function judgment section 120b in place of node function judgment section 120 of FIG. 8.

Node function judgment section 120b, similar to Embodiment 2, basically judges the node 100b that has transmitted the tint P2P wireless communication is the next time section representative node.

However, node function judgment section 120b, each time transmission of the output data by output data generation section 160 is completed, judges that node 100b is not the next time section representative node. In this case, the completion of transmission of the output data as used here indicates the completion of transmission of all sets of output data that indicate accompanying information of the overall ad-hoc network 260. Node function judgment section 120b uses wireless communication section 130 to transmit to another node 100b a notification of the ending of the representative node. The notification of the ending of the representative node is information that gives notification that the functioning of node 100b as a representative node is ended in the current frame.

Each time it receives a notification of the ending of the representative node, node function judgment section 120b judges from the other node 100b that the other node 100b is not the next time section representative node.

During the time that the representative node is present, node function judgment section 120b does not change that representative node. That is, node function judgment section 120b, as long as it does not judge that the next time section representative node of the immediately previous frame (that is the representative node of the current frame) is not the next time section representative node of the current frame (that is, the representative node of the next frame), does not change the representative node.

By doing this, in ad-hoc network 260, until the completion of the transmission of the output data the same node 100b can output accompanying information continuously as the representative node.

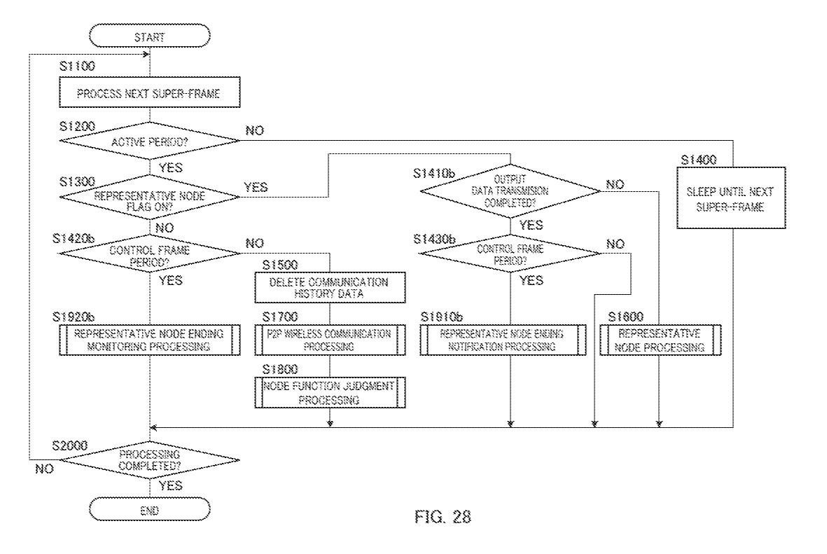

FIG. 28 is a flowchart showing an example of the overall operation of node 100b, this corresponding to FIG. 12 of Embodiment 2. Parts that are the same as those in FIG. 12 are assigned the same step numbers, and the descriptions thereof will be omitted.

If node function judgment section 120b judges that the representative node flag is on (YES at S1300), processing proceeds to step S1410b. If node function judgment section 120b judges that the representative node flag is off (NO at S1300), processing proceeds to step S1420b.

At step S1410b node function judgment section 120b judges whether or not transmission of the output data has been completed. If node function judgment section 120b judges that the transmission of the output data has been completed (YES at S1410b), processing proceeds to step S1430b. If node function judgment section 120b judges that the transmission of the output data has not been completed (NO at S1410b), processing proceeds to step S1600.

In the representative node processing at step S1600, output data generation section 160 need not generate output data and delete representative node data for each flame. That is, for example, in the case in which output data transmitted over a plurality of frames is generated and stored at the first frame, output data generation section 160 can perform only read-out and transmission of the stored output data in subsequent frames.

At step S1430b, node function judgment section 120b judges whether or not it is a control frame period. If the node function judgment section 120b judges that it is a control frame period (YES at S1430b), processing proceeds to step S1910b. If node function judgment section 120b judges that it is not a control frame period (NO at S1430b), processing proceeds to step S2000.

At step S1910b, node function judgment section 120b performs representative node ending notification processing and, if the output data transmission has been completed, makes notification of the ending of the representative node. Details of the representative node ending notification processing will be described later.

At step S1420b, node function judgment section 120b judges whether or not it is a control frame period. If node function judgment section 120b judges that it is a control frame period (YES at S1420b), processing proceeds to step S1920b. If node function judgment section 120b judges that it is not a control frame period (NO at S1420b), processing proceeds to steps S1500, S1700, and S1800.

In the present embodiment, however, in the node function judgment processing at step S1800, only adds representative node data, and does not delete (that is, update) representative node data. This is because deletion of representative node data is done in the representative node ending monitoring processing, which is described later.

At step S1920b, node function judgment section 120b performs representative node ending monitoring processing and monitors whether or not the function of the representative node of the current frame has ended. Details of the representative node ending monitoring processing will be described later.

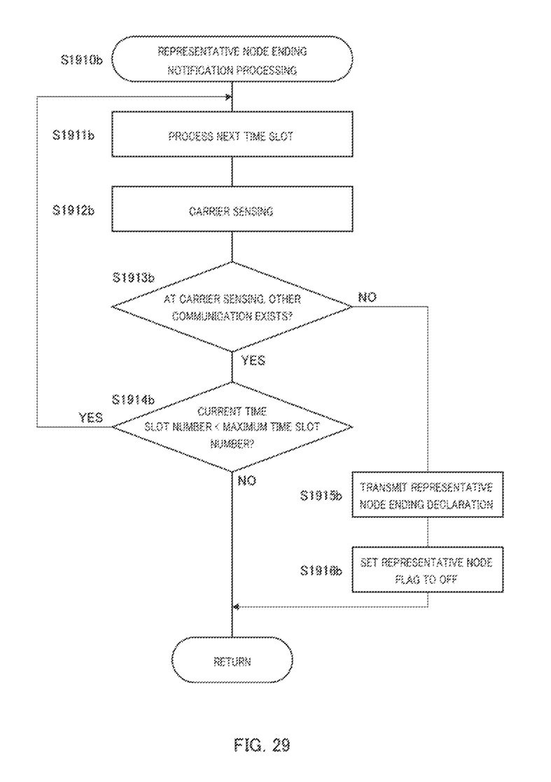

FIG. 29 is a flowchart showing an example of the representative node ending notification processing (S1910b).

First, at step S1911b, node function judgment section 120b waits for the timing of the start of the next time slot, and then starts processing.

Then, at step S1912b, node function judgment section 120b causes wireless communication section 130 to perform carrier sensing.

At step S1913b, node function judgment section 120b judges whether or not, as a result of the carrier sensing, another communication (communication of another node 100b) exists. If node function judgment section 120b judges that there has been another communication (YES at S1913b), processing proceeds to step S1914b. If node function judgment section 120b judges that there is no other communication (NO at S1913b) processing proceeds to step S1915b.

At step S1914b, node function judgment section 120b judges whether or not the current time slot number is smaller than the maximum time slot number. If node function judgment section 120b judges that the current time slot number is smaller than the maximum time slot number (YES at S1914b), processing proceeds to step S1911b. If node function judgment section 120b judges that the current time slot number has reached the maximum time slot number (NO at S1914b) return is made to the processing of FIG. 28.

At step S1915b, node function judgment section 120b transmits a representative node ending declaration to another node 100b of ad-hoc network 260.

At step S1916b, node function judgment section 120b switches the representative node flag to of and returns to the processing of FIG. 28.

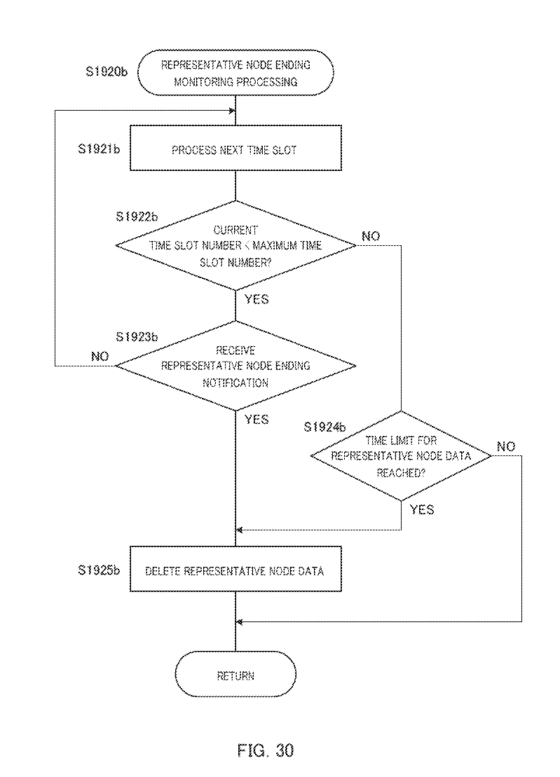

FIG. 30 is a flowchart showing an example of the representative node ending monitoring processing (S1920b).

First, at step S1921b, node function judgment section 120b waits for the timing of the start of the next time slot, and then starts processing.

At step S1922b, node function judgment section 120b judges whether or not the current time slot number is smaller than the maximum time slot number. If node function judgment section 120b judges that the current time slot number is smaller than the maximum time slot number (YES at S1922b), processing proceeds to step S1923b. If node function judgment section 120b judges that the current time slot number has reach the maximum time slot number (NO at S1922b), processing proceeds to step S1924b.

At step S1923b, node function judgment section 120b judges whether or not a representative node ending notification has been received from another node 100b. If node function judgment section 120b judges that that a representative node ending notification has not been received (NO at S1923b), processing proceeds to step S1921b. If node function judgment section 120b judges that a representative node ending notification has been received, (YES at S1923b) processing proceeds to step S1925b.

At step S1925b, node function judgment section 120b causes communication data management section 140 to delete the representative node data corresponding to the origin of the transmission of the representative node ending notification, upon which return is made to the processing of FIG. 28.

At step S1924b, node function judgment section 120b judges whether or not the validity time period of the representative node data has expired. The validity time period is a threshold with regard to the elapsed time from the time of storage or updating of the representative node data. This is because there are cases in which it is not possible to receive the representative node ending notification if, for example, there is a distance to the representative node. If node function judgment section 120b judges that the validity time limit for reception of the representative node ending notification has run out (YES at S1924b), processing proceeds to step S1925b. If node function judgment section 120b judges that the validity time limit of the representative node data has not run out (NO at S1924b), return is made to the processing of FIG. 28.

When node 100b as described above is itself the representative node, even in the case in which the number of frames required to transmit all the accompanying information is indeterminate, it is possible to continue functioning as the representative node until the completion of the transmission. That is, node 100b can transmit the output data across a plurality of frames.

Node 100b may determine the next time section representative node, based not on the first super-frame of a plurality of super-frames in which the representative node does not change, but rather based on the communication history in another prescribed super-frame.

Node 100b other than a representative node may itself not become the representative node until the completion of the transmission of representative node accompanying information. In this case, node 100b can prevent a large number of nodes 100b from becoming representative nodes.

Node 100b may judge the ending of the representative node function, with the pre-condition of straddling a pre-established number of super-frames or frames by the function as the representative node. In this case, node 100b, for example, can count the number of super-frames or frames each time thermo data is generated or updated.

Although in the above-described Embodiment 2 to Embodiment 4 the wireless terminal determines the representative node based on the sequence of usage of time slots in the current time section, this is not a restriction. As long as it is a method that can determine a representative terminal that is common to a plurality of terminals forming an ad-hoc network, the wireless terminal may use another determination method. For example, the wireless terminal according to the present embodiment may make the determination based on another determination rule, such as using identification information of each wireless terminal obtained in the past.

A wireless terminal that plays the role of a fixed wireless base station having large-capacity electrical power such as from a power grid, or a wireless terminal connected to a power supply or mounting a large-capacity battery (hereinafter “static representative wireless terminal”) may be previously set as a representative node. An external communication apparatus such as a wireless base station, access point, or server may be dynamically specified as a representative node and notification may be given to the wireless terminal. A parameter for priority selection as a representative node may be set in a wireless terminal, and exchanged between wireless terminals. Because disposing such static representative wireless terminals in a distributed manner eliminates the need for wireless terminals moving in the vicinity thereof to operation as representative nodes, it is possible to reduce the power consumption of each wireless terminal.

In the case in which a wireless base station performs scheduling with respect to wireless terminals (for example, in a cellular system), the specification of a representative node by a wireless base station is particularly effective, and the optimum representative node is always selected. Doing this eliminates the need for processing to determine the representative node in the wireless terminal. Because an appropriate representative node is determined based on communication (infra-communication 270) between a wireless base station and a wireless terminal and communication (P2P wireless communication 250) between wireless terminals, it is possible to reduce the power consumption at each wireless terminal.

The specification of the representative node by the wireless base station may be made to all wireless terminals connected to the wireless base station, or may be made to only a specific wireless terminal (for example, an active-mode wireless terminal (established as a term in cellular communication), a wireless terminal currently operating as the representative node, or a wireless terminal determined to because the representative node in the next time section). Notifying only a specific wireless terminal enables a reduction of the notification processing burden in the wireless base station and the notification traffic from the wireless base station.

In the case of giving notification to a wireless terminal in the idle mode (established as a term in cellular communication), the wireless base station may make notification using a broadcast channel, may make notification using a paging message, or may make notification after starting the paging processing to activate all the wireless terminals.

Additionally a representative terminal may generate billing information with respect to a wireless terminal that has transmitted accompanying information via a representative terminal, including a static representative wireless terminal, and may give notification to an apparatus (for example, a billing management apparatus) on infra-network 220. A representative terminal may request an apparatus on infra-network 220 to generate billing information. In a representative terminal or an apparatus of infra-network 220 generating billing information, traffic information that is a totalizing of the amount of information transmitted or the number of transmissions may be taken as the billing information for each wireless terminal (e.g., each wireless terminal uniquely identified by a terminal ID or MAC address). By doing this, with respect to a wireless terminal that has had accompanying information transmitted representative terminal, it is possible to have a part of the usage fee paid by the representative node for usage of the corresponding service or cellular system (for example, a fee for the number of packets spend as accompanying information) be borne by the representative terminal. In this manner, by providing a user with a means for obtaining compensation with respect to the user operating as a representative terminal, in addition to achieving overall system fairness, it is possible to obtain fair payback for power consumed during the time in which the wireless terminal operates as a representative terminal. The means of communication used in notification of the traffic information or billing information may be either P2P wireless communication 250 or infra-communication 270.

Although in the above-described Embodiment 2 to Embodiment 4 the wireless terminal performs external communication by wireless communication with the infra-network or serial communication with the UI apparatus, this is not a restriction. The wireless terminal may, for example, perform wired communication another wireless communication apparatus as external communication.

Also, although in the above-described Embodiment 2 to Embodiment 4 the wireless terminal was a terminal carried by a user, this is not a restriction. The wireless terminal according to embodiments of the present invention may be another type of terminal, such as a wireless terminal mounted aboard a bicycle or automobile.

The disclosure of Japanese Patent Application No. 2011-124388, filed on Jun. 2, 2011, including the specification, drawings and abstract, is incorporated herein by reference in its entirety.

### INDUSTRIAL APPLICABILITY

The wireless terminal and wire communication method according to the present invention are suitable for use a wireless terminal, a wireless communication method, and a wireless communication system capable of transmitting accompanying information of an ad-hoc network to an external network while reducing drop-outs.

### REFERENCE SIGNS LIST

100, 100a, 100b Wireless terminal (node)
110 Time slot management section
120, 120a, 120b Node function judgment section
130 Wireless communication section
140 Communication data management section
150 External interface section
160 Output data generation section
170 Output data management section
200 Accompanying data management section
210 Wireless base station
220 Infra-network
230 Server
240 User
250 Ad-hoc communication (P2P communication)
260 Ad-hoc network
270 Infra-communication
401 Wireless apparatus
402 UI apparatus
410 P2P communication antenna.
420 Wireless section
420b Wireless communication section
430 Infra-communication antenna
440 Communication section
441, 442 External communication section
450 CPU
451 CPU of Wireless apparatus
452 CPU of Terminal
460, 461, 462 Memory
470 Display section

1. A wireless terminal that is one of a plurality of terminals forming an ad-hoc network and that performs ad-hoc communication and external communication at different times, the wireless terminal comprising:
a node function judgment section that determines a representative terminal common to the plurality of terminals, for each time section made by dividing a time axis;
a wireless communication section that performs the ad-hoc communication in a time section in which the wireless terminal is not the representative terminal;
a communication data management section that stores a communication history of the ad-hoc communication and representative terminal information indicating which terminal was the representative terminal;
an external interface section that performs the external communication; and
an output data generation section that, in the time section in which the wireless terminal is the representative terminal, transmits to an external network, using the external interface section, the communication history and representative terminal information in association with each other.

2. The wireless terminal according to claim 1, wherein:
the node function judgment section determines the representative terminal from the terminals included in the communication history; and
the representative terminal information indicates which terminal was the representative terminal in an at least immediately previous one of the time sections.

3. The wireless terminal according to claim 2, wherein:
the communication data management section stores at least: a communication history table in which at least the reception time of received data from the terminal other than the representative terminal and identification information of that terminal are described; and a representative node data table in which at least the reception time of received data from the terminal that is the representative terminal and identification information of that representative terminal are described; and
the output data generation section generates output data in which the described contents of the communication history table and the representative node data table are combined, and transmits the generated output data to the external network.

4. The wireless terminal according to claim 3, wherein the communication data management section, for each starting of the time section in which the wireless terminal is not the representative node, initializes the communication history table, and the communication data management section, for each ending of the time section in which the wireless terminal is the representative node, initializes the representative node data table.

5. The wireless terminal according to claim 4, further comprising an output data management section that temporarily stores the output data that has been transmitted by the output data generation section to the external network, wherein
the external interface section, when transmission of the output data fails, obtains the corresponding output data from the output data management section and transmits the obtained output data to the external network.

6. The wireless terminal according to claim 2, wherein the time section is one or a plurality of frames,
the wireless terminal further comprising a time slot management section that manages the frames and a plurality of time slots made by dividing the frames, wherein
the wireless communication section, for at least each one of the time sections, randomly selects a time slot from the plurality of time slots and transmits data in the ad-hoc communication in the selected time slot.

7. The wireless terminal according to claim 6, wherein, for each one of the time sections in a predetermined one or more of the frames,
when a number of data receptions by the ad-hoc communication in the time slot before the selected time slot is not greater than a prescribed number, the node function judgment section judges that the wireless terminal is the representative terminal in the next time section, and
when the number of data receptions by the ad-hoc communication in the time slot before the selected time slot is at least a prescribed number, the node function judgment section judges that the transmission origin of the received data is the representative terminal in the next time section.

8. The wireless terminal according to claim 6, wherein, for each one of the time sections in a predetermined one or more of the frames,
when there is no data reception by the ad-hoc communication in the time slot before the selected time slot, the node function judgment section judges that the wireless terminal is the representative terminal in the next time section, and
when there has been data reception by the ad-hoc communication in the time slot before the selected time slot, the node function judgment section judges that the transmission origin of the received data is the representative terminal in the next time section.

9. The wireless terminal according to claim 6, wherein,
when the node function judgment section sends a representative node declaration to another terminal and also receives a response to the declaration, the node function judgment section judges that the wireless terminal is the representative terminal in the next time section, and
when the node function judgment section receives the representative node declaration from another terminal and also transmits a response to the declaration, the node function judgment section judges that the other terminal is the representative terminal of the next time section.

10. The wireless terminal according to claim 6, wherein,
for each completion of transmission of the output data by the output data generation section, the node function judgment section judges that the wireless terminal is not the representative terminal of the next time section and transmits a representative node ending notification to another terminal, and
for each reception of the representative node ending notification from another terminal, the node function judgment section judges that the other terminal is not the representative terminal in the next time section and does not change the representative terminal during the time in which the representative terminal is present.

11. A wireless communication method in a wireless terminal that is one of a plurality of terminals forming an ad-hoc network and that performs ad-hoc communication and external communication at different times, the method comprising:
determining a representative terminal common to the plurality of terminals, for each time section made by dividing a time axis;
performing the ad-hoc communication in a time section in which the wireless terminal is not the representative terminal;
accumulating a communication history of the ad-hoc communication; and
transmitting to an external network, in the time section in which the wireless terminal is the representative terminal, the communication history and representative terminal information indicating which wireless terminal is the representative terminal in association with each other.

12. A wireless communication system comprising a plurality of wireless terminals each being one of a plurality of terminals forming an ad-hoc network and performing ad-hoc communication and external communication at different times, wherein
the wireless terminal comprises:
a node function judgment section that determines a representative terminal common to the plurality of terminals, for each time section made by dividing the time axis;
a wireless communication section that performs the ad-hoc communication in a time section in which the wireless terminal is not the representative terminal;
a communication data management section that stores a communication history of the ad-hoc communication and representative terminal information indicating which terminal was the representative terminal;
an external interface section that performs the external communication; and
an output data generation section that, in the time section in which the wireless terminal is the representative terminal, transmits to an external network, using the external interface section, the communication history and representative terminal information in association with each other, wherein
the plurality of wireless terminals include a terminal that is previously set as the representative terminal.
